(19) United States
(12) Patent Application Publication
(10) Pub. No.: US 2020/0174516 A1
(43) Pub. Date: Jun. 4, 2020

(54) Sports Retronic Wearable Terminal And The Same

(71) Applicant: Clarence Patrick Wheeler, Atlanta, GA (US)

(72) Inventor: Clarence Patrick Wheeler, Atlanta, GA (US)

(21) Appl. No.: 16/594,062

(22) Filed: Feb. 3, 2020

Related U.S. Application Data
(63) Continuation-in-part of application No. 15/936,426, filed on Mar. 26, 2018.

(51) Int. Cl. G06F 1/16; A44C 5/00; G06F 3/0488

(52) U.S. Cl. CPC G06F 1/163; G06F 3/04883; A44C 5/003

(57) ABSTRACT

The present invention discloses an Sports Retronic Wearable Terminal worn by athletes. The wearable terminal comprises an wrist sleeve portion comprising an plurality of layers, an plurality of input buttons disposed on its exterior surface and an plurality of smartphone and micro-components coupled to the one or more interior layers configured to preform a number of task. The Sports Retronic Wearable Terminal comprises an display assembly disposed on the wrist sleeve portion exterior surface made of one or more layers configured to display an image and/or video via an display. The Sports Retronic Wearable Terminal also comprises an flap assembly coupled to the display assembly made of one or more layers when the terminal is an folding type, the flap assembly comprises an sack portion which hold an play-card or similar object, an pull-tab which allocates an user to separate the flap assembly from the display assembly.

### FIELD OF THE INVENTION

The invention generally relates to the field of wearable terminals. More specifically, the invention relates to an wearable terminal used by athletes in sports.

### BRIEF SUMMARY OF THE PRESENT INVENTION AND ADVANTAGES

The present invention comprises the field of wearable terminals. The wearable terminal may be formed of an fabric material (e.g., such as microfiber and cotton), rubber and silicone that may allocate the wearable terminal to stretch and adapt to fit many different wrist shape and sizes without the need for complex adjustments. The wearable terminal may be worn like a watch, wristband, sweatband or similar object around the wrist or arm of a user. The wearable terminal comprises an flexible display assembly made of one or more flexible layer, an wrist sleeve portion made up of one or more layers and an flap assembly comprising an sack portion and an pull-tab.

The wearable terminal may comprise one or more flexible printed-circuit intergraded within the wrist sleeve portion that may comprise one or more electrical components populated onto its surface that may allocate wireless communication with an external device, and input and output interaction with the user of the wearable terminal. Specifically, the one or more flexible printed circuits may contain several micro smart-phone components, WIFI and Bluetooth chipset, an micro processor, one or more sensors, intended to power the wearable terminal and its components, exchange and receive playbook data and store the playbook files. The wearable terminal may furthermore be water-resistance making the device substantial to all weather conditions.

### BRIEF DESCRIPTION OF THE SEVERAL VIEWS OF THE DRAWINGS

FIG. 1 is a shape diagram for describing a one or more electrical components populated onto one or more printed circuit films within the Sports Retronic Wearable Terminal.

FIG. 2 is a perspective view, illustrating the Sports Retronic Wearable Terminal according to one embodiment of the present invention.

FIG. 3A is an cross-sectional view of the wrist sleeve portion according to one embodiment.

FIG. 3B is an cross-sectional view of the wrist sleeve portion broken away shown the multiple layer according to one embodiment.

FIG. 3C is an cross-sectional view schematically illustrating the wrist sleeve portion according to another embodiment.

FIG. 3D is an cross-sectional view schematically illustrating the multi-layer associated with the wrist sleeve portion according to another embodiment.

FIG. 4A is an schematic diagram of the flexible display assembly.

FIG. 4B is an exploded view of the one or more components of the flexible display assembly.

FIGS. 4C & 4D is an illustration of an schematic diagram of the flexible display assembly stacked layers.

FIGS. 4E & 4F are cross-sectional views of the one or more stacked layers relatively to the flexible display assembly.

FIG. 5A illustrates the wrist sleeve portion in relations with the one or more cutout (CO).

FIG. 5B illustrates the wrist sleeve portion in relations with the one or more means for securing to the wrist of an user.

FIG. 6 is an illustration of the wrist sleeve portion in conjunction with one or more electrical components integrated within the wrist sleeve portion.

FIG. 7A is an rear perspective view of the flexible keymat.

FIG. 7B is an front perspective view of the flexible keymat.

FIG. 7C is an cross-view perspective of the flexible keymat disposed on the one or more integrated layers of the mist sleeve portion.

FIG. 7D is an top view perspective of the key top.

FIG. 7E is an bottom view perspective of the key top.

FIG. 7F is an illustration of the one or more key tops disposed on the wrist sleeve portion.

FIG. 7G is an cross-sectional view of one or snore additional components disposed on the exterior layer of the wrist sleeve portion.

FIG. 7H is an cross-sectional view of one or more additional components integrated within the wrist sleeve portion.

FIG. 8A is an perspective view of the Sports Retronic Wearable Terminal having an flexible display assembly and an respective flap assembly.

FIG. 8B is an illustration of the flexible plastic sack.

FIG. 8C is an cross-sectional view of the flexible plastic sack disposed within the flap assembly.

FIG. 8D is an cross-sectional view illustrating the flexible display assembly in relations to the flap assembly.

FIG. 8E is an cross-sectional view illustrating the pull-tab in relations to the flap assembly.

FIG. 9a-10 is an summary of a display screen illustrating disposition of execution opening of an object on the display of an mobile terminal according to an exemplary embodiment of the present invention.

FIG. 11 is method step for executing function of a object according to an embodiment of the present invention.

### DETAILED DESCRIPTION OF THE INVENTION

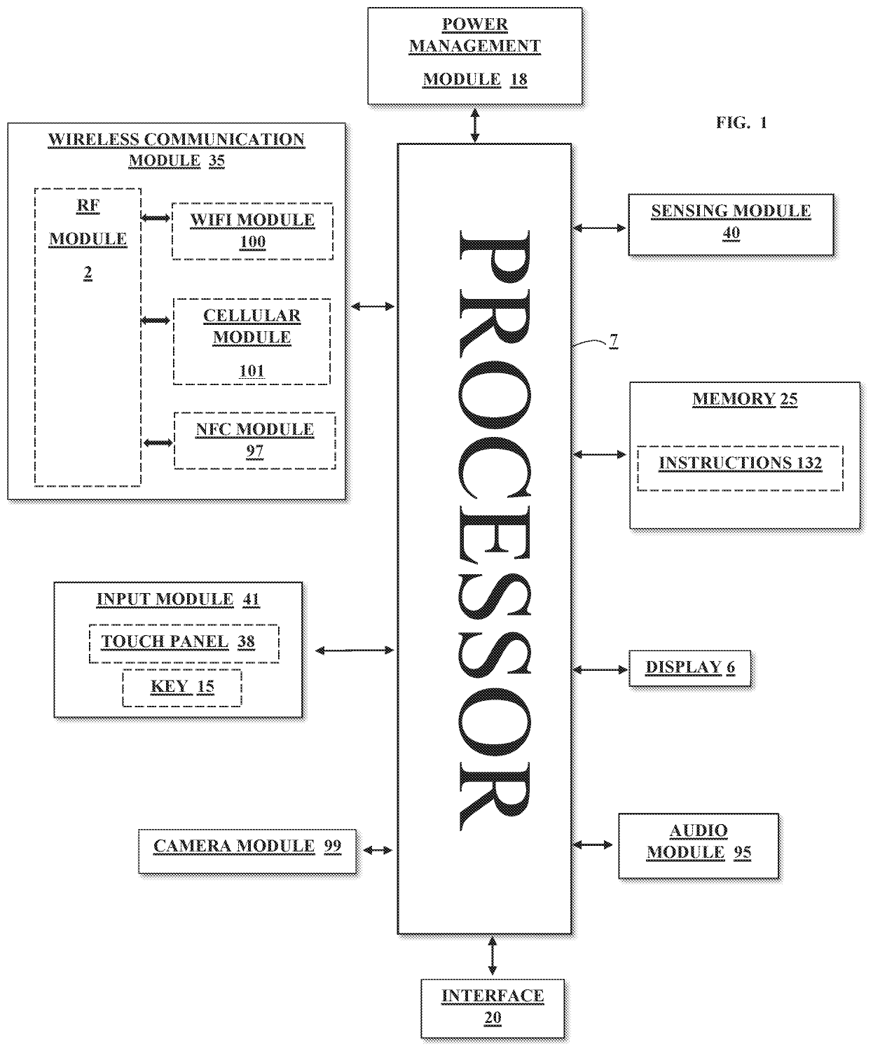

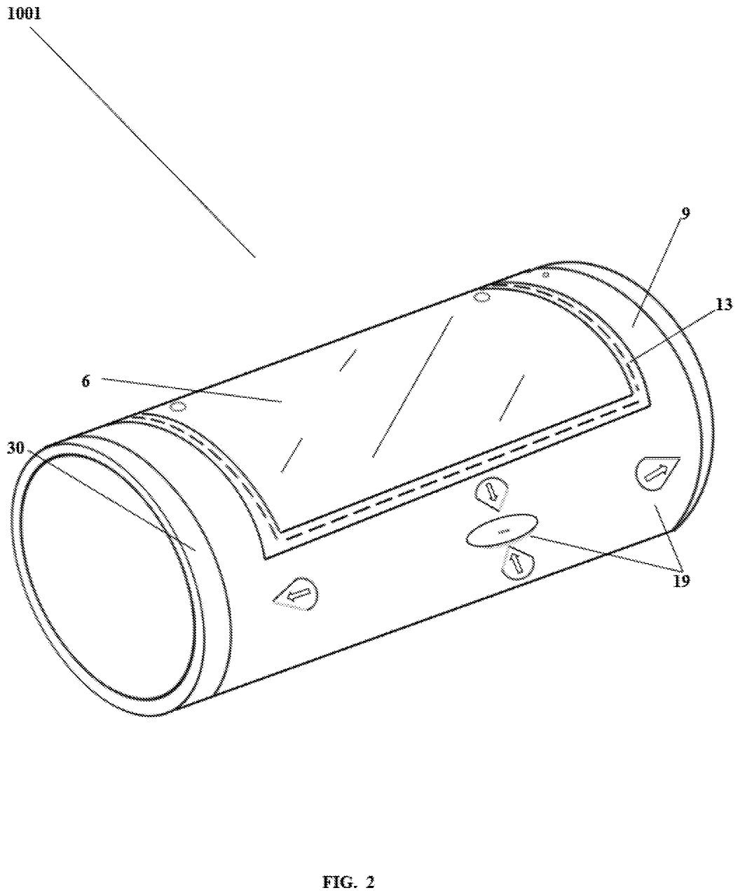

FIG. 1 is an block diagram describing components that may be coupled to the one or more flexible printed circuits of the Sports Retronic Wearable Terminal 1001. Furthermore, Sports Retronic Wearable Terminal 1001 may include one or more processor 7 which may control a multitude of hardware or software components that may be connected thereon and may also perform various data processing and operations by executing an operating system application program, or operating system and application instructions. The processor 7 may be implemented with a system on chip (SoC). The processor 7 may further include a graphic processing unit (GPU) and/or an image signal processor. For example, processor 7 duties may be to load commands or data received from one or more components and process them and store various data in a nonvolatile memory. During operation, the processor 7 executes one or more programs stored within the memory 25 and controls the general operation of the program instructions.

The wireless communication module 35 comprises an RF module 2, WIFI module 100, cellular module 101, and an NFC module 97. The wireless communication module 35 allows wireless communication which may enable the remote interaction between Sports Retronic Wearable Terminal 1001 and an external device and or via internet, which may include communication systems as PAN (Personal Area Network), NFC (Near Field Communication), Zigbee, Bluetooth, RFID (Radio Frequency Identification), IrDA, (Infrared Data Association), LAN (Local Area Network), WIFI, MAN (Metropolitan Area Network) WiMAX (World Interoperability for Microwave Access), HSDPA (High Speed Downlink Packet Access), WAN (Wide Area Network), Wibro (Wireless Broadband), UWB (Ultra-Wideband), LMDS (Local Multiple Distribution Service), IPV6 (Internet Protocol Version 6), and RF (Radio Frequency) communication systems. The wireless communication module 35 may include a processor for processing data transmitted/received through a corresponding module and or may be included in one integrated chip (IC) or IC package.

The RF module 2, for example, may be used to transmit/receive communication signals. The RF module 2 may include a transceiver, a power amp module (PAM), a frequency filter, a low noise amplifier (LNA), or an antenna.

The cellular module 101, for example, may allocate voice call, video call, text service, or internet service through an communication network. The cellular module 101 may perform a distinction and authentication operation in a communication network by using an SIM card or virtual SIM card. The WiFi module 100, and NFC module 97 may include a processor for processing data transmitted/received through a corresponding module. The present disclosure, at least part (e.g., at least one) of the cellular module 101, the WiFi module 100 and NFC module 97 may be included in one integrated chip (IC) or IC package. At least one of the cellular module 101, the WiFi module 100 and the NIT module 97 may transmit/receive RF signals through a separate RF module.

The Sports Retronic Wearable Terminal 1001 may include an memory 25, an internal memory that may comprise a SSD (Solid State Drive), NAS (Network Attached Storage), Dual-Channel RAM (Random Access Memory), Multi-ROM (Read-Only Memory), Flash Memory (Flash Memory Type), Hard Disk (Hard Disk Type), Multimedia Card Micro (Multimedia Card Micro Type), SRAM (Static Random Access Memory), EEPROM (Electrically Erasable Programmable Read-Only Memory), PROM (Programmable Read-Only Memory), may further include a card type memory Compact Flash (CF), Secure Digital (SD), Micro Micro-SD, Mini-SD, Extreme Digital (xD), Multimedia Card (MMC) or a memory stick. The memory 25 may store the operating system components, application data, graphics and critical system files, many of the previously mentioned files and systems may be separated to different storage chips throughout flexible printed circuit-board. The memory 25 also stores one or more instructions 131 for executing of rearranging the icon layout on the display 6 and instructions 132 for generating a object opening execution region 314 in response to a user first action with one or more objects 1009 on the display 6.

The Sports Retronic Wearable Terminal 1001 may include a power management module 18 that may be an off-chip ex. (module) or on-chip, duties to manage the power of the Sports Retronic Wareable Terminal 1001. The power management module 18 may include a power management IC (PMIC), a charger IC, or a battery gauge, for example. The PMIC may have a wired and/or wireless charging capabilities. In order to implement the wireless charging function the Sports Retronic Wearable Terminal 1001 may comprise one or more coils that may obtain one or more power control signals via an external apparatus via an NFC function, the one or more coils may be connected to one or more communication processor and a charge Integrated Circuit (IC), respectively. An NFC IC or a Wireless Charger (WC) IC may be on a connection of the one or more coils to a circuit of the Sports Retronic Wearable Terminal 1001. These ICs control current and Voltage during charging operations, Alternatively, the Sports Retronic Wearable Terminal 1001 may obtain an wireless power via the one or more antennas via an radio frequency signals from an external apparatus and harvest wireless power from the radio frequency signals using one or more rectifiers circuitry.

The Sports Retronic Wearable Terminal 1001 may include one or more input module 41 which may be composed of one or more key(s) 15 and an touch panel 38 (static pressure/electrostatic), the touch panel 38 may use at least one of capacitive, resistive, infrared, or ultrasonic method, for example. Additionally, the touch panel 38 may further include a control circuit, alternatively the touch panel 38 may further include a tactile layer to provide tactile response to a user. The key 15 may include a physical button, an optical key, or a keypad.

Sensing module 40 may measure physical quantities or detect an operating state of Sports Retronic Wearable Terminal 1001, thereby converting the measured or detected information into electrical signals, and may accommodate many different sensors (ex. gesture sensor, gyro sensor, barometric sensor, magnetic sensor, acceleration sensor, grip sensor, proximity sensor, temperature/humidity sensor, illumination sensor, infrared (IR) sensor. The sensing module 40 may further include a control circuit which may control at least one sensor therein and an additional processor to control the sensing module 40 while the main processor may be in a sleep or consumption state.

The display 6 may be an LCD (Liquid Crystal Display), a thin film TLCD (Transistor-Liquid Crystal Display), OLED (Organic Light-Emitting Diode), a Flexible Display, 3-D Display (may include at least one of 3D displays) and may incorporate a touch sensor. Some of these displays may be configured to be transparent to view the outside through them. This may be called a transparent display, for example a transparent display and the like (Transparent Organic Light Emitting Diode) TOLED.

The display 6 according to the implementation of Sports Retronic Wearable Terminal 1001 may also be two or more. For example, it may be provided in the Sports Retronic Wearable Terminal 1001 at the same time the external display module (not illustrated) and an internal display module (not illustrated). The touch panel 38 may be configured to detect even a touch input as well as the position and area of the touch input pressure. The interface 20 may include a high-definition multimedia interface (HDMI), a universal serial bus (USB), an optical interface, or a D-subminiature (sub). Alternatively, the interface 20 may include a mobile high definition link (MHL) interface, secure digital (SD) card/multi-media card (MMC) interface, or an infrared data association (IrDA) standard interface.

The interface 20 may include an high-definition multimedia interface (HDMI), a universal serial bus (USB), an optical interface, or a D-subminiature (sub). The interface 20 may be included in the communication interface, Additionally or alternatively, the interface 20 may include a mobile high definition link (MHL) interface, a secure Digital (SD) card/multi-media card (MMC) interface, or an infrared data association (IrDA) standard interface. The audio module 95 may convert sound into electrical signals and convert electrical signals into sounds. At least some components of the audio module 95 may be included in the input/output interface. The audio module 95 processes sound information inputted/outputted through a speaker, a receiver, an earphone, or a microphone.

The camera module 99, which captures still images and video, may include at least one image sensor (e.g., a front sensor or a rear sensor), a lens, an image signal processor (ISP), or a flash (for example, an LED or a xenon lamp).

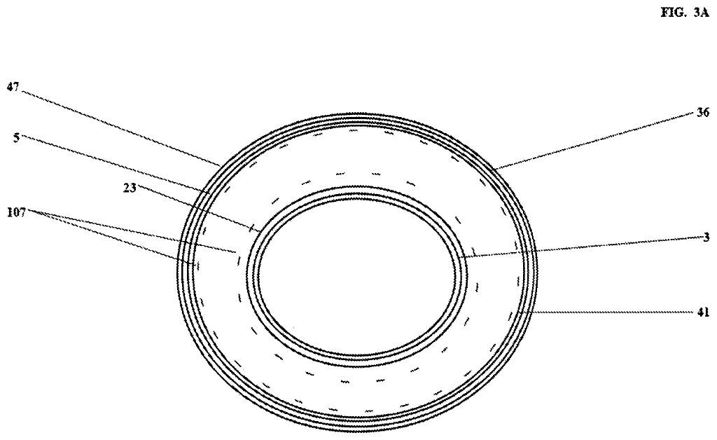

Referring to FIG. 2 describes the Sports Retronic Wearable Terminal 1001, the Sports Retronic Wearable Terminal 1001 comprises an wrist sleeve portion 9 and an display assembly 13. The wrist-sleeve portion 9 comprises an planar body inclosing the wrist and forearm area of an user, the wrist sleeve portion 9 may be formed of an suitable material which allocates flexibility as well as strength. For instance, suitable materials may be nylon, polyester, cotton fabric, leather, plastic or a combination thereof. Additionally, suitable materials may be one or more fabrics and/or materials formed from polymer, metal, glass, graphite, ceramic, natural materials such as bamboo, or other organic and inorganic materials or an combination of the two. The fabrics and/or materials may be made of single filament stands (e.g., micro-fibers), may be yarns or other strands formed by intertwining multiple filaments of materials together. Monofilaments formed from polymer cores with metal coatings and monofilaments formed from three or more layers may also be used. The wrist sleeve portion 9 may comprise one or more additional layers integrated intermediate its exterior layer 47 and interior layer 14 configured to add additional protection, durability and allocate one or more electrical components and/or circuits to integrate within the wrist sleeve portion 9. Further, the wrist sleeve portion 9 comprises an respective cuff edge 30 at opposing sides prolonging around the user's wrist and forearm region. For, instance the cuff edge 30 may be made of an different material as the wrist sleeve portion 9 and the cuff edge 30 region may be intergraded with an elastic material.

The Sports Retronic Wearable Terminal 1001 comprises an plurality of keytops 19 disposed on its surface envisioned to allocate the user to navigate one or more settings or execute one or more action on the one or more programs such as selecting and viewing multimedia file or powering on and off the apparatus.

The Sports Retronic Wearable Terminal 1001 may comprise an means for securing the wrist sleeve portion 9 to an user wrist via respective attachment strips 46 that may be coupled to an predetermine lower region of wrist sleeve portion 9 exterior layer 47. The attachment strips 46 may be formed of the same materials as the wrist sleeve portion 9. Alternatively, the attachment strips 46 may be formed of an suitable strong and flexible material, such as nylon, or an inelastic material. The attachment strips 46 inner surface comprises an complementary hook or loop material such as that sold under the trademark VELCRO®. The attachment strips 46 length may be sufficient so that when the front region is pulled towards the backside region inclosing around the user wrist and/or forearm the attachment strips 46 comprises adequate length to mate with the velcro pad(s) 27 disposed at the rear side region with minimal tension.

The display assembly 13 may comprise one or more layers that allocates support and for the display layer 6. The display assembly 13 form an quadrilateral-shape comprising an center opening 10 constituting an window structure may of an suitable material which allocates flexibility as well as strength. Suitable materials may be made of an thin flexible plastic or rubber material or an combination thereof. For example, one or more layers of an light weight flexible plastic or rubber material such as thermoplastic, ethylene vinyl acetate (EVA), Kraton styrene polymer, PVC, ENGAGE, or an polyethylene polymer may be laminated, printed, or molded to form the display assembly 13 into an suitable thickness.

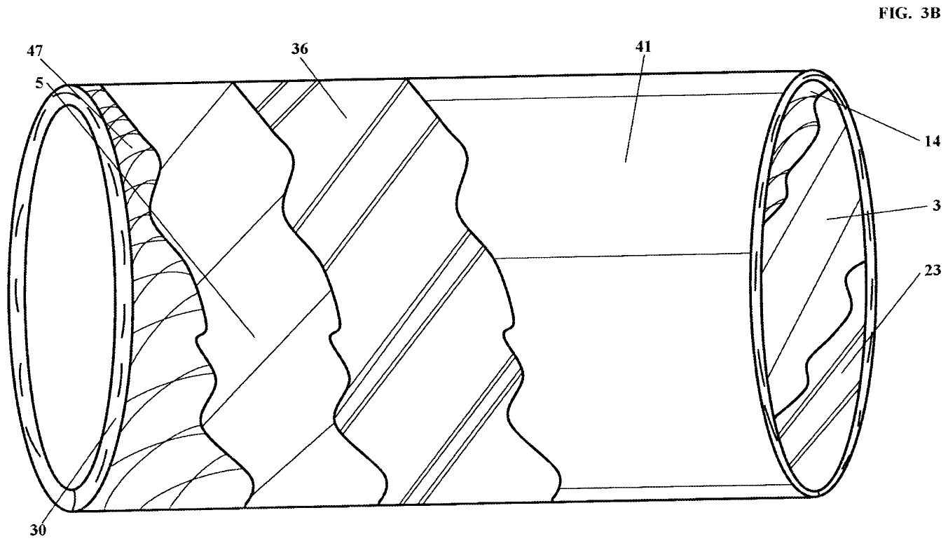

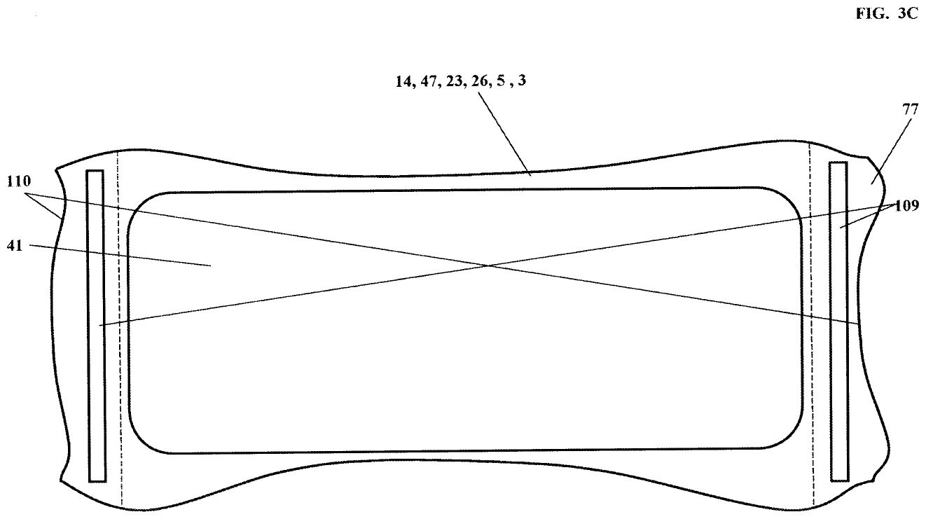

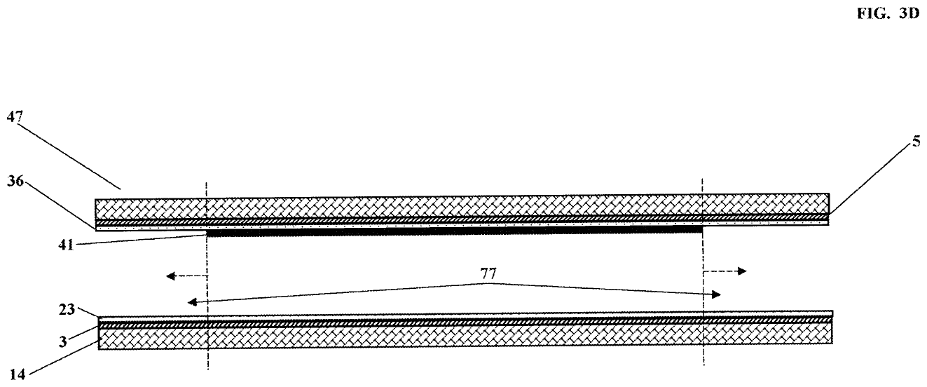

FIG. 3A is an cross-sectional view of the wrist sleeve portion 9 according to one embodiment, FIG. 3B is an cross-sectional view of the wrist sleeve portion 9 broken away shown the multiple layer according to one embodiment.

FIG. 3C is an cross-sectional view schematically illustrating the wrist sleeve portion 9 according to another embodiment. FIG. 3D is an cross-sectional view schematically illustrating the wrist sleeve portion 9 multiple layer according to another embodiment.

According to the present embodiment, the wrist sleeve portion 9 comprises an exterior layer 47 superimposing the interior layer 14 forming an multi-layer film. The exterior layer 47 comprise an intermediate layer 5 and inner layer 36. The exterior layer 47 is formed from of a suitable material such a woven or non/woven fabrics made of natural and/or synthetic fibers or a flexible plastic material. The exterior layer 47 comprises any suitable thickness in the range of 0.5 mm and up. The intermediate layer 5 is formed of an liquid absorbent and containing material such as cellulose, preferably viscose rayon, a synthetic shammy material. The intermediate layer 5 comprises any suitable thickness in the range of 0.3 mm and up. The inner layer 36 is formed of an flexible rubber material. The inner layer 36 disposed on the intermediate layer 5 may be used for permanently restricting liquid substances from penetrating the structuring layer 41 and electrical components disposed on the structuring layer 41. The inner layer 36 comprises any suitable thickness in the range of 0.2 mm and up. To form the multi-layer exterior layer 47, the exterior layer 47 properties can be efficiently co-extruded forming an multi-layer film, which can then be micro-fibrillated to produce a microfiber article having a desired combination of properties based on the composition and properties of the different layers of the co-extruded film. Alternatively, the exterior layer 47 may be prepared by forming an respective exterior layer 47, intermediate layer 5 and inner layer 36 and laminating or adhesion the layers to one another to form an multi-layer film.

Further, included is an interior layer 14 comprising an outer surface in contact with the wrist of an user, an inner layer 23 disposed on the interior layer 14 surface at an non-contact position on the user wrist and an intermediate layer 3 disposed on the inner layer surface at an non-contact position with the user wrist forming an multi-layer film. The interior layer 14 may also be formed from a suitable material such as a woven or non/woven fabrics made of natural and/or synthetic fibers or a flexible plastic material. The interior layer 14 comprises any suitable thickness in the range of 0.5 mm and up. The intermediate layer 3 is formed of an liquid absorbent and containing material such as cellulose, preferably viscose rayon, a synthetic shammy material.

The intermediate layer 3 comprises any suitable thickness in the range of 0.3 mm and up. The inner layer 23 is formed of an flexible rubber material. The inner layer 23 disposed on the intermediate layer 3 may be used for permanently restricting liquid substances from penetrating the structuring layer 41 and electrical components disposed on the structuring layer 41 from the inner wrist region. The inner layer 23 comprises any suitable thickness in the range of 0.2 mm and up. To form the multi-layer interior layer 14, the interior layer 14 properties can be efficiently co-extruded forming an multi-layer film, which can then be micro-fibrillated to produce a microfiber article having a desired combination of properties based on the composition and properties of the different layers of the co-extruded film. Alternatively, the interior layer 14 may be prepared by forming an respective interior layer 14, intermediate layer 3 and inner layer 23 and laminating or adhesion the layers to one another to form an multi-layer film.

Further, disposed on the interior layer 14 intermediate layer top surface or exterior layer 47 intermediate layer bottom surface is an respective flexible structuring layer 41 adapted to house one or more electrical components on its surface. To do this the structuring layer 41 comprises one or more adhesive layers made of an thermoplastic material having an low melting point disposed on its top surface, which allocates the first and second flexible printed circuits (34, 72) to be laminated or thermally adhered to the structuring layer 41 top surface and one or more electrical components to be disposed on its top surface. The structuring layer 41 may be coupled to the intermediate layer by one or more adhesive bonds on lamination processes. The structuring layer 41 is made of an flexible rubber material. The structuring layer 3 comprises any suitable thickness in the range of 0.3 mm and up. The structuring layer 41 may also comprise an thin adhesive cover layer disposed on its top surface providing an extra protective cover for the one or more printed circuit films and/or electrical components populated onto the printed circuit films made of an polypropylene, polyethylene terephthalate, polyamide polyimide or other suitable materials or an combination thereof. The structuring layer 41 comprises an thickness in the range of 0.3 mm and up.

Moreover, in process of sandwiching the respective interior layer 14, exterior layer 41 and structuring layer 4 together the distal edges of each layer are stitched together forming an single panel and the distal edges 110 of the single panel edges are cuffed inward and stitched constituting cuffed edges 30.

Specifically, upon sandwiching the inner layer 23, 36, intermediate layer 5, 3 and structuring layer 41 to the exterior layer 47 and interior layer 14 the exterior layer 47 and interior layer 14 comprises in the range of 3 mm and up of excess layer 77 surrounding the structuring layer 41 which allocates an elastic strip 109 to be disposed adjacent the panel distal edges 110 without overlapping the structuring layer 41 wherein the panel distal edges 110 are cuffed inward stitching the elastic strip 109 within the cuffed edges 30 constituting an stretchable edge region FIGS. 3C & 3D.

However, the plurality of layers of the wrist sleeve portion 9 in reference to FIGS. 3A-3D, the one or more layers of the wrist sleeve portion 9 can be coupled together to form a multi-film layer by a lamination, co-extrusion or adhesive process. For example, the one or more layers of the wrist sleeve portion 9 may be coupled together by a co-extrusion process, the wrist sleeve portion 9 may comprise a exterior layer 47 and interior layer 14 having the same property's (e.g., plastic material or woven or non-woven microfiber material), a non-microfiber inner layer 36 and inner layer 23 having the same property's (e.g., flexible rubber material) and a structuring layer 41 intermediate the inner layers (36, 23) having similar property's of the inner layers (36, 23). Further, the properties of the one or more layers can combine to produce a flexible rubber or elastomeric cloth-like article with a microfiber surface that might independently be hydrophobic, hydrophilic, oleophobic, oleophilic, etc. Or, the different layers may be chosen to have different microfiber surface properties, or preferred mechanical properties. The one or more layers may be transformed into a single article (e.g., wrist sleeve portion 9) using standard methods of microfibrillation, including hydroentanglement techniques using a hydrogen tangling machine. The one or more layers of the multi-layer film, and different amounts or thicknesses of the one or more layers, may be microfibrillated to form microfibers.

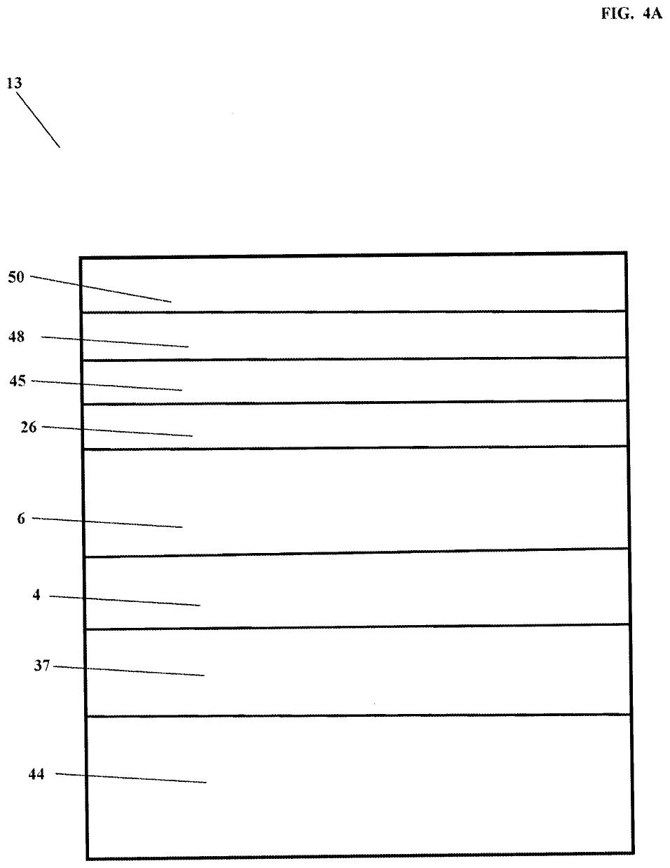

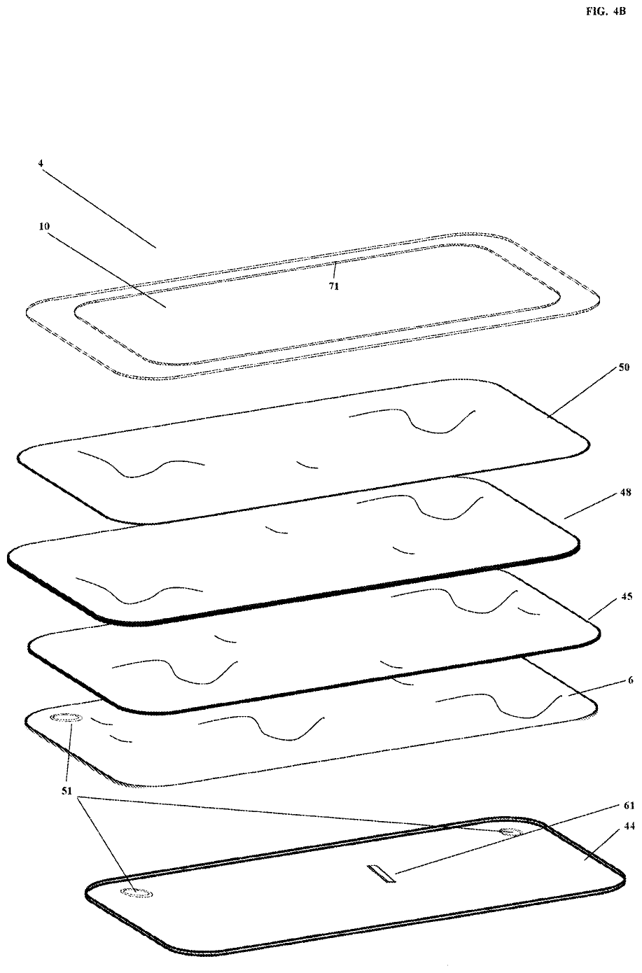

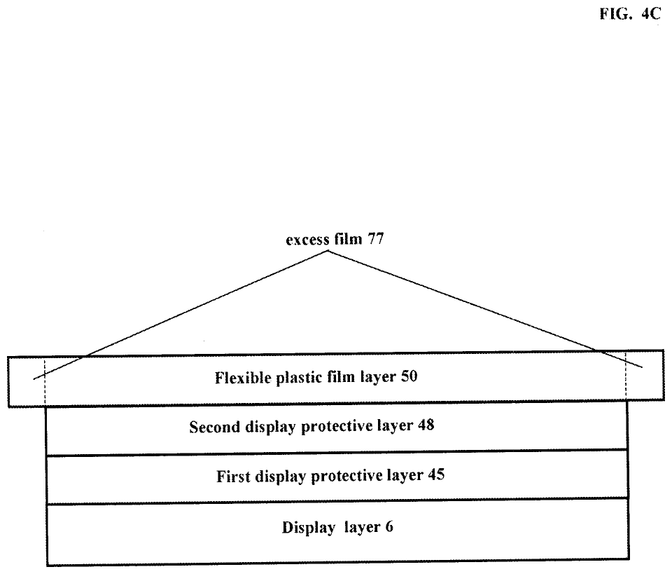

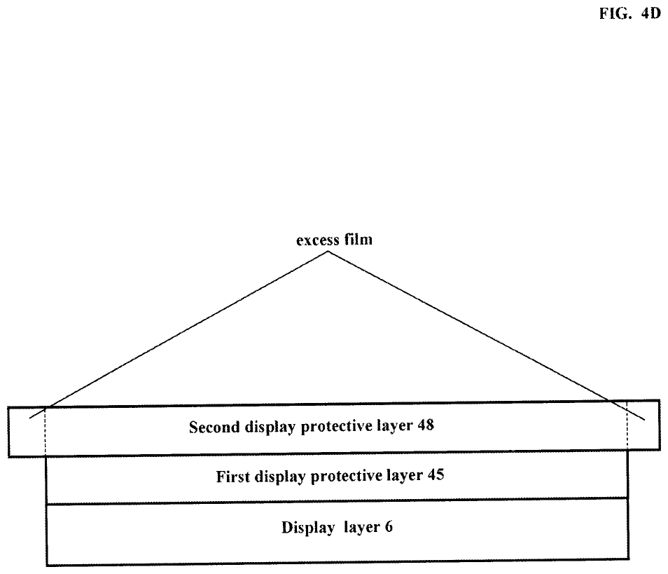

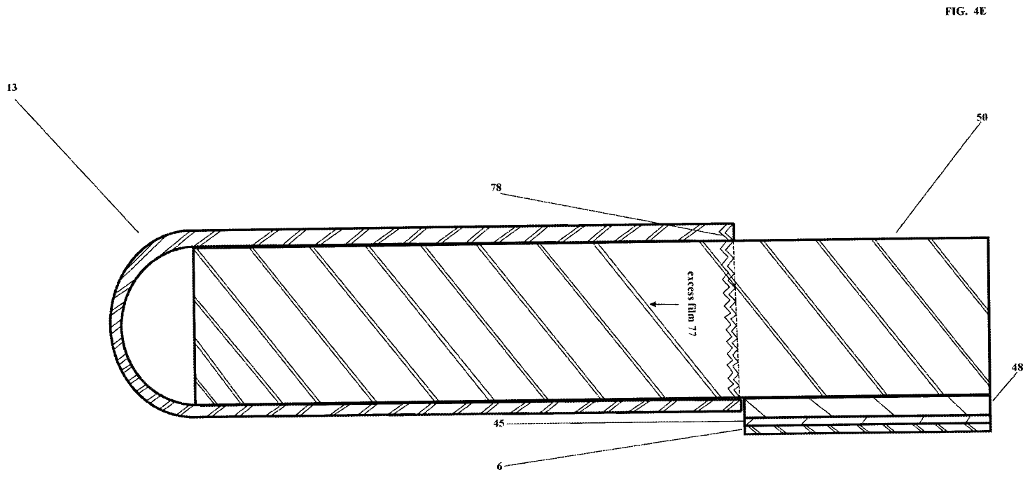

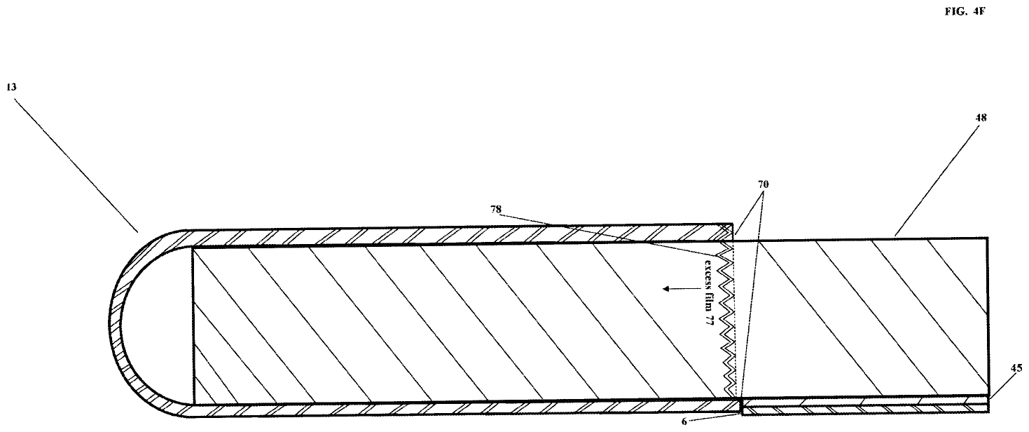

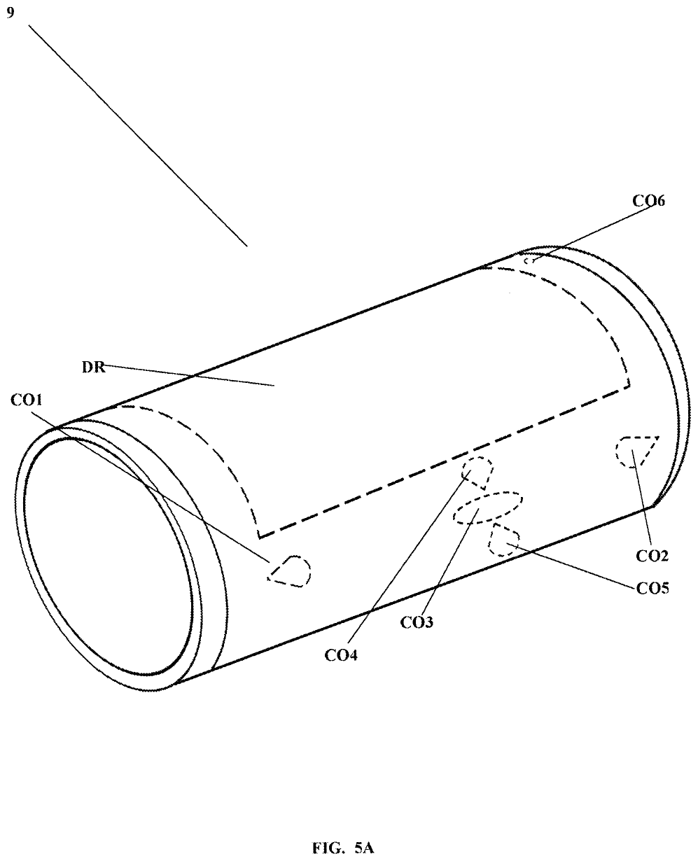

Referring to FIG. 4A, is an schematic diagram of the flexible display assembly 13 having an plurality of respective stacked layers. While FIG. 4B is an exploded view of the flexible display assembly 13. FIG. 4C and FIG. 4D is an illustration of an schematic diagram of the one or more flexible display assembly 13 stacked layers. FIGS. 4E & 4F are cross-sectional views of the one or more stacked layers disposed within the flexible display assembly 13. The flexible display assembly 13 is further disposed on the exterior layer 47 surface at the display region (DR) via one or more coupling processes (e.g., adhesive bonding, stitching or an combination thereof), and further configured to display an image and/or video on the display 6 upon obtaining data (e.g., multimedia message and etc.) from an external apparatus (e.g., such as an notebook or desktop computer) via an wireless communication network. Further, the wrist sleeve portion 9 comprises an flexible display assembly 13 having an flexible window housing 4, display 6, first display protective layer 45, second display protective layer 48 and an rear cover layer 44.

The display 6 a flexible organic light-emitting diode (OLED), light-emitting diode (LED) or liquid crystal display (LCD) is disposed within the flexible window housing 4 center opening 10. The display 6 is further configured to display an image and/or video on the display 6 upon obtaining data (e.g., playbook information) from an external apparatus (e.g., such as an notebook or desktop computer) via an wireless communication network. In addition, the display 6 may also include one or more touch-sensitive elements configured to detect an user's touch at predetermine regions on the flexible display assembly 13 and to generate electrical signals in response to the detected touch. In addition, the display 6 comprises two spherical-shape cutouts 51 at opposing upper regions of its surface. The spherical-shape cutouts 51 are further positioned to allocate one or more sensor lens (e.g., light emitting elements and proximity sensors) to arrange within the spherical-shape cutouts 51. The plastic film layer may be to protect the display 6 front surface. The flexible window housing 4 can be made of an silicone rubber, leather or flexible plastic material, In the present embodiment, the display 6 is disposed on the first display protective layer 45 via an optically clear adhesive (OCA) layer 26. To do this the optically clear adhesive layer 26 is applied to the bottom surface of the first display protective layer 45 and the display 6 may be applied to the bottom surface of the first display protective layer 45. The first display protective layer 45 is made of an thin flexible transparent material, comprising any suitable thickness of in the range of 0.1 mm and up.

Further, the first display protective layer 45 can be coupled to the second display protective layer 48 via an optically clear adhesive layer 26, where the optically clear layer 26 is applied to the rear surface of the second display protective layer 48 or front surface of the first display protective layer 45. The second display protective layer 48 is made of an thin flexible transparent material, comprising any suitable thickness in the range of 0.05 mm. Otherwise, the first display protective layer 45 rear region may comprise an adhesive surface which allocates coupling the display 6 to its surface.

The first display protective layer 45 and second display protective layer 48 may be coupled to the display 6 to protect the front surface of the display 6 from scratches, cracks and liquid substances. In general, different adjacent discrete layers of the display assembly 13 may be joined by an adhesive material between the adjacent materials. Adhesive material between an optical path from the display emitters of the display 6 and user's eye are OCA.

Further, the display 6 comprising the first and second display protective layers 48, 45 is coupled to the flexible window housing 4 in or more ways. In the first instance, an flexible plastic film layer 50 is coupled to the second display protective layer 48 via an thin optically, clear adhesive layer 26, where the optically clear adhesive layer 26 is applied to the rear surface of the flexible plastic film layer 50. The flexible plastic film layer 50 is made of an thin flexible plastic transparent material, comprising any suitable thickness of approximately 0.05 mm and up. The flexible plastic film layer 50 may be to protect the first display protective layer 45, second display protective layer 48 and display 6 front surface from further damages.

The display 6 comprising the first and second display protective layers 48, 45 and flexible plastic film layer 50 is coupled within the flexible window housing 4 via an stitching and adhesive process. Specifically, the flexible window housing 4 forms an reedy quadrilateral-shape with outer edges that partially curve. The flexible window housing 4 comprises an center opening 10 that prolongs outwardly leaving approximately 11.43 mm and up of the flexible window housing 4 constituting an window enter opening). To couple the display 6 to the flexible window housing 4 the flexible window housing 4 inner lips 70 are partially bifurcated to allocate the flexible plastic film layer 50 excess film 77 (begins at dashed lines) be inserted within the inner lips 70, an small amount of adhesive may be applied to the inner surface of the inner lips 70, the flexible plastic film layer 50 excess film 77 is then disposed within the inner lips 70 and the flexible window housing 4 is stitched 78 at one or more regions near its boarding (e.g., outer edges and an opposing predetermine region) coupling the flexible plastic film layer 50 to the flexible window housing 4. However, upon coupling the second display protective layer 48 to the flexible plastic film layer 50, the flexible plastic film layer 50 comprises in the range of 3 mm and up of excess film 77 boarding the second display protective layer 48, first display protective layer 45 and display 6 this allocate the flexible plastic film layer 50 to be disposed within the flexible window housing 4 inner lips 70 without damaging the first and second display protective layer 48, 45 and display layer 6 FIGS. 4C & 4E.

Alternatively, the display 6 comprising the first and second display protective layer 48, 45 is directly coupled to the flexible window housing 4 without the intervene of an flexible plastic film layer 50. To do this, an small amount of adhesive is disposed within the flexible window housing 4 inner lips 70, the second display protective display layer 48 excess film 77 (begins at dashed lines) is disposed within the flexible window housing 4 inner lips 70 and the flexible window housing 4 is stitched 78 at one or more regions near its boarding (e.g., outer edges and an opposing predetermine region) coupling the second display protective layer 48 within the flexible window housing 4. Specifically, upon coupling the second display protective layer 48 to the first display protective layer 45 and display layer 6 the second display protective layer 48 comprises in the range of 3 mm and up of excess film 77 boarding the first display protective layer 45 and display layer 6 this allocate the second display protective layer 45 to be disposed within the flexible window housing 4 inner lips 70 without damaging the first display protective layer 45 and display layer 6 FIGS. 4D & 4F.

The flexible plastic film layer 50 is made of an thin flexible plastic transparent material, comprising any suitable thickness in the range of 0.05 mm and up. The flexible plastic film layer 50 may be to protect the first display protective layer 45, second display protective layer 48 and display 6 front surface from further damages.

The flexible window housing 4 is made of an silicone rubber, leather or flexible plastic material. The flexible window housing 4 comprises any suitable thickness in the range of 1.27 mm and up. For instance, one or more layers of rubber, leather, gel or plastic material may be laminated, bonded or 3D-printed together to form the flexible window layer 4. In some implementations, the rear cover/support structure 44 is disposed on the rear surface of the flexible window housing 4 via an adhesive layer 37. In some implementations, the rear cover/support structure 44 may be bonded to the rear surface of the flexible window housing 4 via an adhesive. Further, the rear cover/support structure 44 forms an reedy quadrilateral-shape layer with outer edges the partially curve, also corresponding with the dimensions of the flexible window housing 4. Specifically, the rear cover/support structure 44 is formed of an flexible rubber material having an heavier density than the flexible window housing 4. This higher density level may limit over bending of the display assembly 13, for instance the flexible window housing 4 may comprises an density in the range of 0.001 kg to 0.01 kg and the rear cover/support structure 44 may comprise an density in the range of 0.005 kg to 0.02 kg.

The rear cover/support structure 44 is further made of an flexible rubber material. The rear cover/support structure 44 comprises an thickness of approximately 3.35 mm and up. The rear cover/support structure 44 further comprises two spherical-shape cutouts 51 at opposing upper regions of its surface and one or more incisions 62 disposed at an predetermine region below the two spherical-shape cutouts 51. The spherical-shape cutouts 51 are further positioned to allocate one or more sensor lens (e.g., light emitting elements and proximity sensors) to arrange within the spherical-shape cutouts 51.

However, the one or more incision 62 may be formed to allocate the display 6 ribbon to deviate the rear cover/support structure 44 and introduce into the wrist sleeve portion 9 incision 62 to couple to the first flexible printed circuit 34.

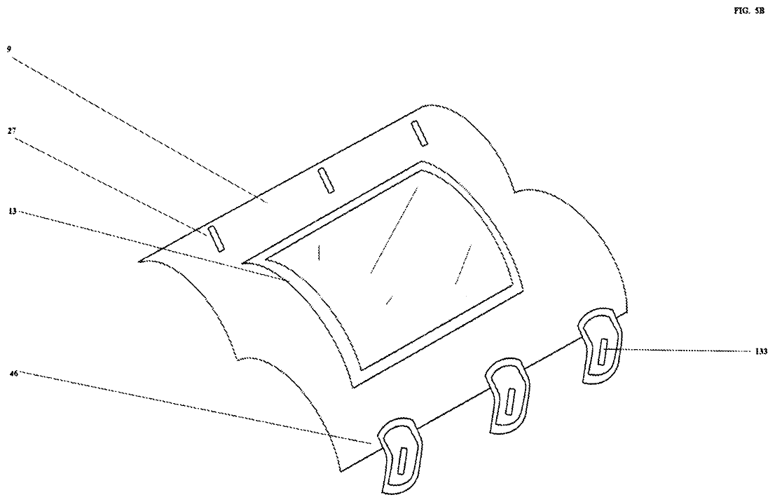

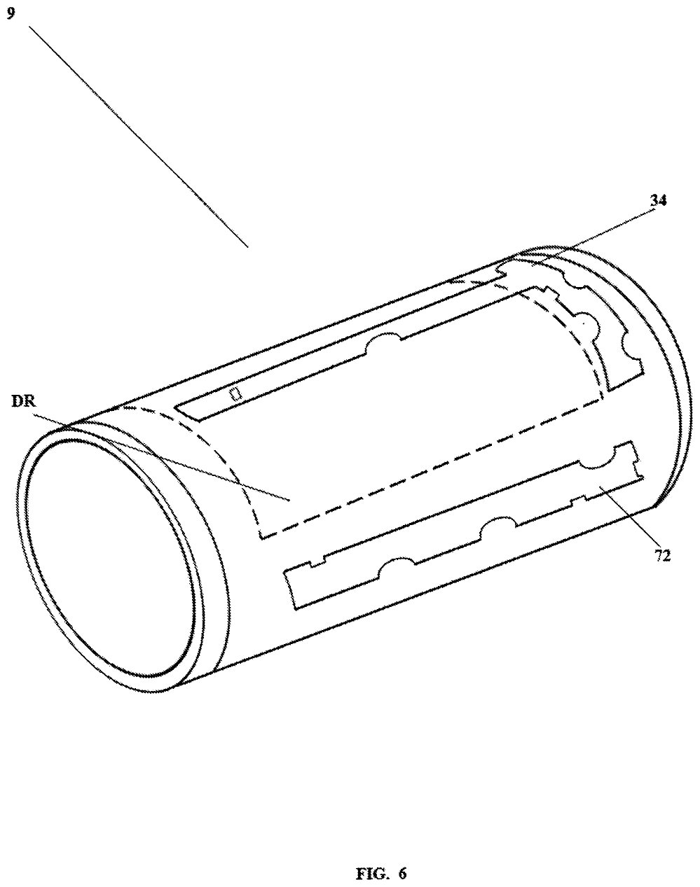

FIG. 5A illustrates the wrist sleeve portion 9 in relations with the one or more cutout (CO) indicated as clashed-lines. FIG. 5B illustrates the wrist sleeve portion 9 in relations with the one or more means for securing to the wrist of an user. As mentioned above in FIG. 3A-3E the wrist sleeve portion 9 comprises an interior layer 14 comprising an intermediate layer 5 and inner layer 23. An exterior layer 47 comprising an intermediate layer 3 and inner layer 36. An structuring layer 41 disposed intermediate the exterior layer 47 and interior layer 14 intermediate layers 3, 5. Specifically, the cutouts are formed on the exterior layer 47, intermediate layer 3 and inner layer 36 where each cutout location formed on each layer corresponds with the opposing layer cutout location. For instance, the cutouts (CO) and incision 32 on the wrist sleeve portion 9 may be formed before coupling the respective layer together by an rotary tool, laser or any suitable tool or machine. This way the cutouts and slits are formed on the exterior layer 47, intermediate layer 3 and inner layer 36, therefore when the flexible keymat 22 is coupled to the inner layer 36 top surface each key location may arrange within the one or more cutout (CO) openings and the one or more key tops 19 may be coupled to the flexible keymat 22. Alternatively, other suitable cutting methods may also be used to form the cutouts (CO), incisions 32 and openings 51 on the wrist sleeve portion 9.

Moreover, the wrist sleeve potion 9 comprises an plurality of cutouts (CO) formed at predetermine regions of its surface. Additionally, the wrist sleeve potion 9 comprises one or more incisions 32 and openings 51 formed at the display region (DR), which may allocate the display 6 ribbon access to couple to the first flexible printed circuit 34 and the one or more sensors lens to arrange within the one or more openings 51. The display region (DR) signifies an region on the exterior layer 47 where the display assembly 13 is respectively coupled to the wrist sleeve portion 9.

Specifically, the exterior layer 47, intermediate layer 3 and inner layer 36 comprises four quarter-pie shaped cutouts (CO1), (CO2), (CO4) and (CO5) spaced respectively from one another at predetermine regions, an oval-shape cutout 3 (CO3) centering the four quarter-pie shape cutouts (CO1, CO2, CO4, CO5) and an respective spherical-shape cutout (CO6) arranged above the quarter-pie shape cutout (CO2). According to cutouts (CO1 and CO2) the curved region faces outward while the opposing pointed region faces inward. More of spherical-shape cutout 6 (CO6) is smaller than oval shape cutout 3 (CO3). Further, the spherical-shape cutout 6 (CO6) may be formed to house an power button or power status indicator such as an light emitting dioxide (LED).

Specifically, cutout (CO1) 1 arranges at an far left-side, cutout (CO2) 2 arranges at an opposing far right-side of the wrist sleeve portion 9 slightly below the display region (DR), while cutout (CO3) 3 arranges slightly below the display region (DR) intermediate cutout 4 (CO4) and cutout 5 (CO5) while cutout 6 (CO6) arranges above cutout (CO2) 2. The cutouts formed on the wrist sleeve portion 9 allocates the one or more key tops 19 (e.g., physical input buttons) to be disposed onto the flexible keymat 22 and to allocating physical interaction from an user.

Additionally, the wrist sleeve portion 9 further comprises one or more means of securing the wrist sleeve portion 9 to the user wrist or forearm such as an hook and loop-type fastener such as Velcro® or other connecting means such as a buckle or snaps. in the preferred embodiment the front region of the wrist sleeve portion 9 comprises three respective attachment strips 46 positioned at the front lower region vertically overhanging the wrist sleeve portion 9. Specifically, the attachment strips 46 is disposed at an front lower side of the wrist sleeve portion 9 below the four quarter-pie shaped keytops 19 and spherical-shape keytop 19.

Each attachment strip 46 comprises an respective quadrilateral-shaped velcro strip 133 on its inner surface disposed at the region where the attachment strip 46 overhangs away from the wrist sleeve portion 9. Further, the attachment strips 46 may be coupled to the wrist sleeve portion 9 by one or more stitching processes. The attachment strips 46 may be made of the microfiber material or another material such as an leather or flexible plastic. The velcro strips 133 may be coupled to the attachment strip 46 by one or more adhesive processes or stitching processes.

Also in the preferred embodiment, the rear region of the wrist sleeve portion 9 comprises three respective quadrilateral-shape velcro pads 27 slightly adjacent one another laterally, arranged at an lower region of the wrist sleeve portion 9 rear surface. Each velcro pad 27 arranges vertically on the wrist sleeve portion 9 rear outer surface, corresponding with the attachment strip 46 velcro strip 133 when the front region is pulled towards the rear region. Further, the attachment strips 46 may be coupled to the wrist sleeve portion 9 by one or more adhesive or stitching processes.

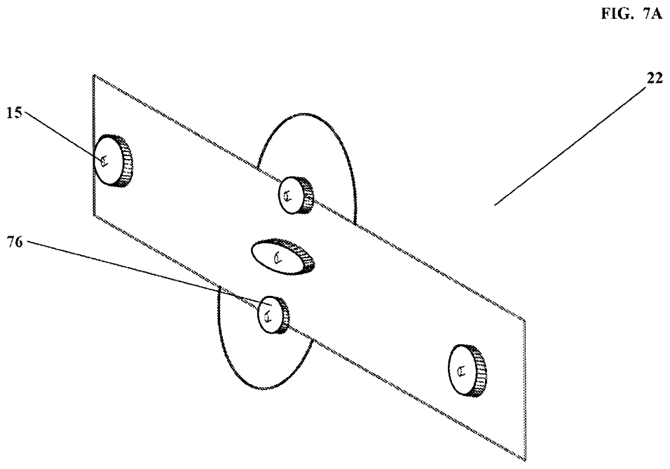

FIG. 6 illustrates the wrist sleeve portion 9 in conjunction with one or more electrical components integrated within the wrist sleeve portion 9. As mentioned above in FIG. 3 the wrist sleeve portion 9 comprises an exterior layer 47, intermediate layer 3, inner layer 36 and structuring layer 41. In the embodiment, the wrist sleeve portion 9 comprises an first flexible printed circuit 34 and second flexible printed circuit 72 comprising one or more micro electrical components populated onto its outer surface disposed onto the structuring layer 41 top surface.

More of, the structuring layer 41 comprises an first flexible printed circuit (FPC) 34 forming an T-shape disposed on the its top surface. Further, the first flexible printed circuit 34 comprises an perpendicular region and lateral region, wherein the lateral region is lengthier than the perpendicular region and wherein the lateral region is disposed beneath the display region (DR).

For instance, the first flexible printed circuit 34 may be coupled to the structuring layer 41 top surface via applying and adhesive to its bottom surface directly coupling the first flexible printed circuit 34 to the structuring layer 41 without the intervene of other suitable structures. To do this the top surface of the structuring layer 3 may comprise an thin adhesive layer made of an thermoplastic material having an low melting point disposed on its top surface. Upon coupling the first flexible printed circuit (FPC) 34 to the adhesive layer of the structuring layer 3 the one or more electrical components may be populated onto the flexible printed circuit 34 via an adhesive or soldering bond without degrading the prior layers. In addition the structuring layer 41 comprises an second flexible printed circuit (FPC) 72 forming an quadrilateral-shape disposed on the its top surface. Specifically, the second flexible printed circuit 72 is disposed at laterally at an lower region of the structuring layer 41, beneath CO1, CO2, CO3, CO4 and CO5. In addition, the second flexible printed circuit 72 may comprise an dome sheet comprising one or more contact pads for obtaining contact from the one or more keydome switches 28.

Further, the micro-electrical components populated onto the first and second flexible printed circuit 34, 72 is one or more processors, light emitting diodes (LEDs), an input module, wireless communication module, one or more memory(s), power management module, audio modules, camera modules and a sensing module.

The first and second flexible printed circuit 34, 72 may comprise one or more thin coatings or layers of an transparent conductive overcoat (TCO) or indium tin oxide (ITO) or the like) disposed on its top surface thereof, and with a metallic layer or coating (such as an opaque or partially opaque or partially transparent metallic layer or coating, such as, for example, a copper layer or coating, a chromium layer or coating, a niobium layer or coating, a neodymium layer or coating, a silver layer or coating, a molybdenum layer or coating, and/or a layer or coating of alloys of the mentioned metals).

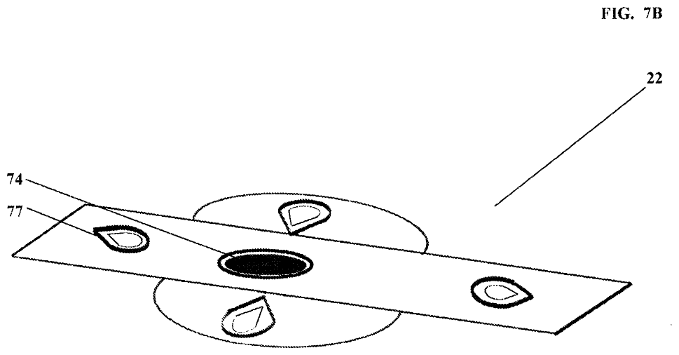

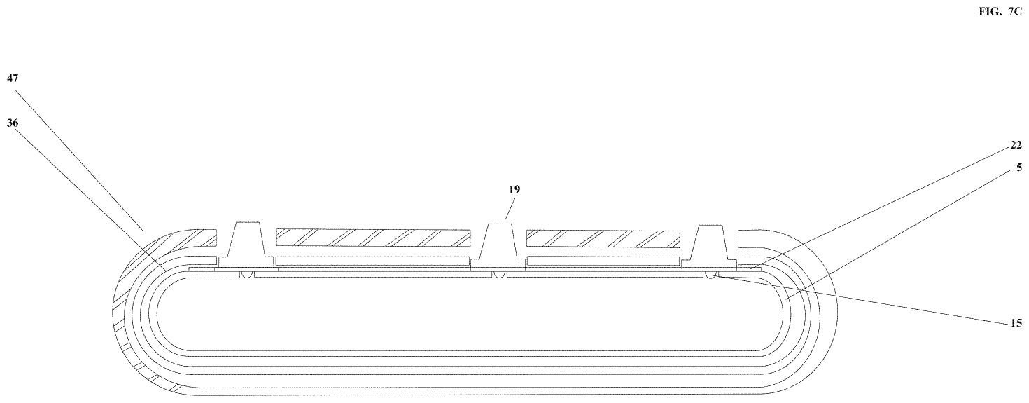

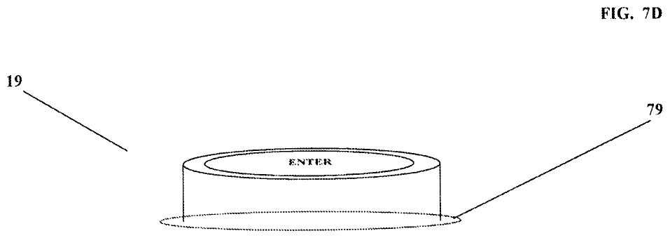

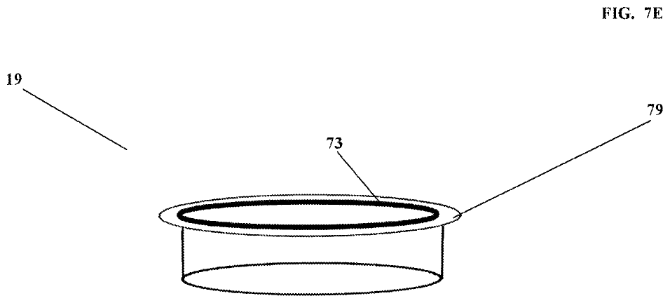

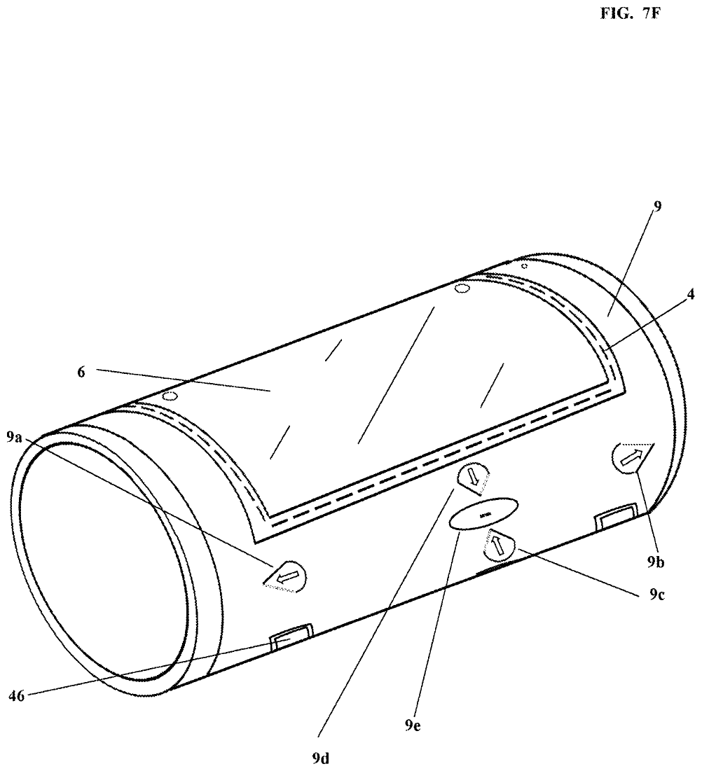

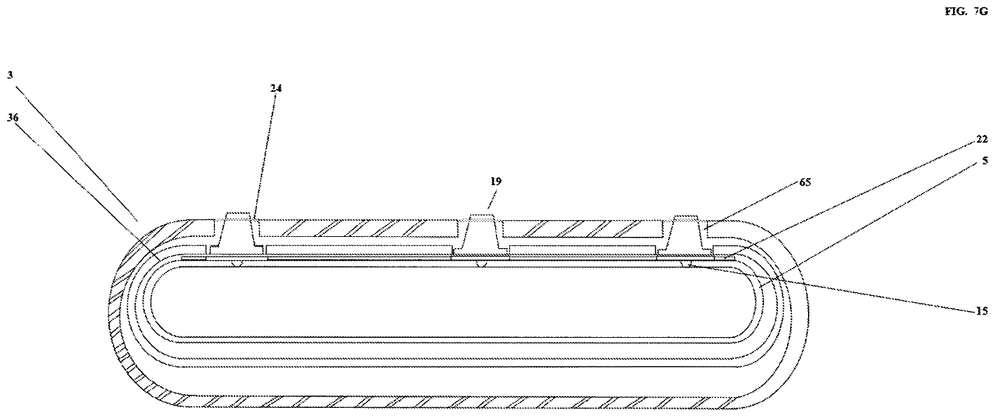

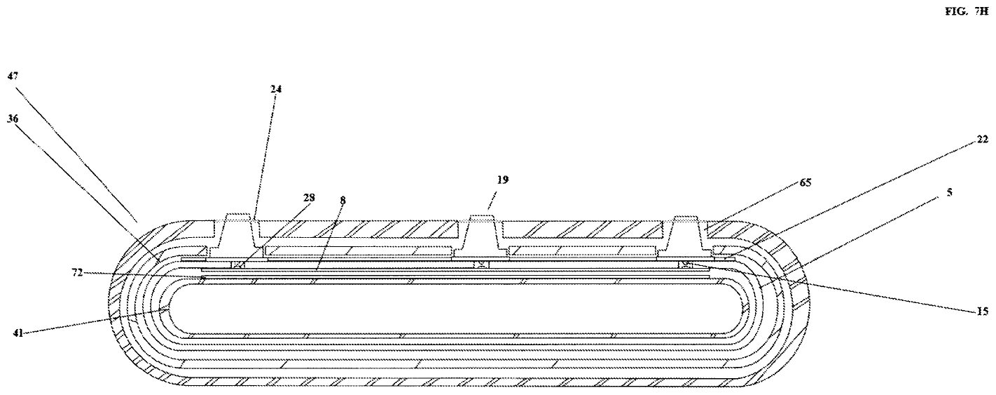

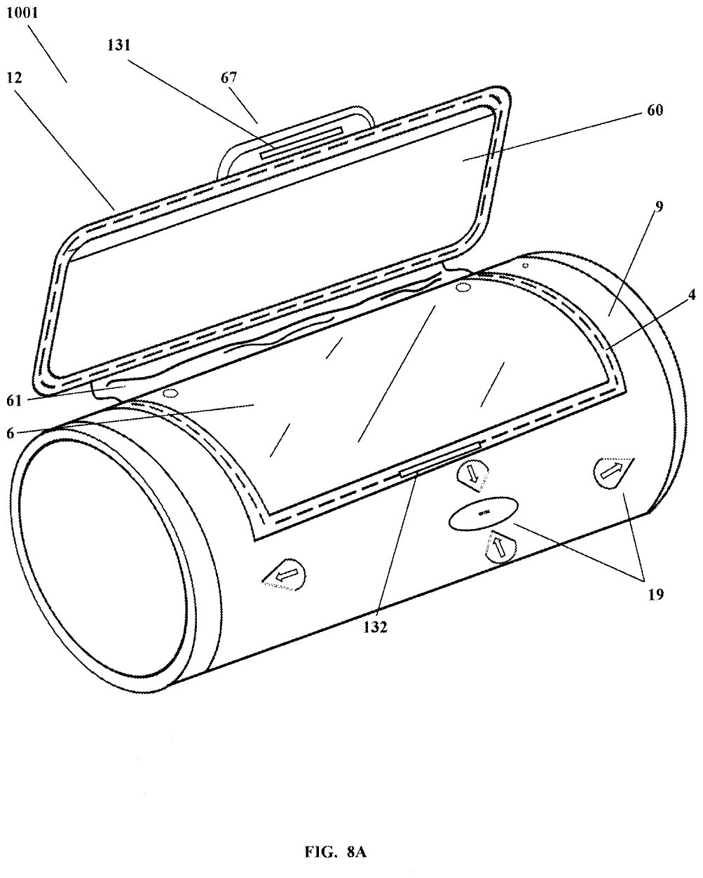

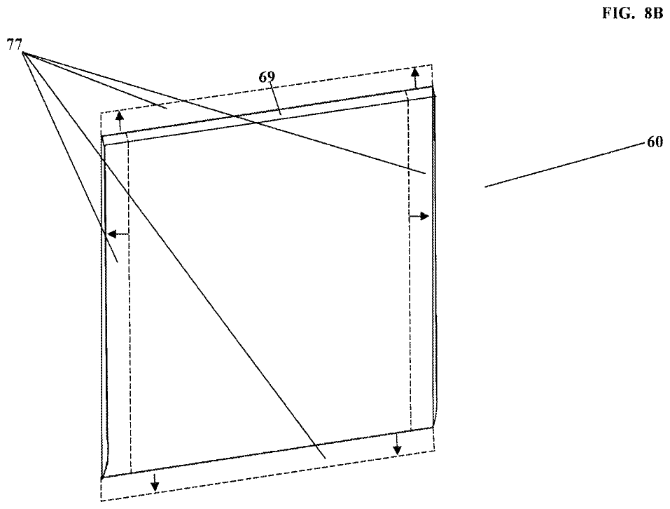

Further FIG. 7A is an rear view of the flexible keymat 22. FIG. 7B is an front view of the flexible keymat 22. FIG. 7C is an cross-view of the flexible keymat 22 disposed on the one or more layers of the wrist sleeve portion 9. FIG. 7D is an top view of the key top 19. FIG. 7E is an bottom view of the key top 19. FIG. 7F is an illustration of the one or more key tops 19 disposed on the wrist sleeve portion 9. FIG. 7G is an cross-sectional view of one or more additional components disposed on the exterior layer 47 of the wrist sleeve portion 9. FIG. 7G is an cross-sectional view of one or more additional components integrated within the wrist sleeve portion 9.

As mentioned above the wrist sleeve portion 9 structuring layer 41 top surface comprises an second flexible printed circuit 72 disposed at it top surface comprising an plurality of contact pads for obtaining contact from the keydome switches 28, in response to an user depressing the one or more key tops 19 on the flexible keymat 22.

The keyboard assembly comprises an flexible keymat 22 forming an quadrilateral-shape segment having an circular region at an mid region of it body. The flexible keymat 22 is further made or an light-transmitting silicon rubber, or an thermoplastic elastomer, i.e., a light-transmitting, flexible rubber material. Further, the flexible keymat 22 forms an thin structure layer having an partial recessed region 74 at the front side of each key location, whereas the partial recessed region 74 constitutes an slight bulge 76 at the rear side of each key location, and further comprising an upward projecting lip 77 at the front side of each key location rim FIGS. 7A & 7B. For example, the key dome keymat actuator 15 disposed at each key location bulge 76 may allocates interaction with an respective key dome switch 28, in response to an user depressing an respective key top 19.

More of, the flexible keymat 22 comprises six respective key locations formed on its top surface, and arranging within the wrist sleeve portion 9 cutouts when assemble to the inner layer 5 top surface. Specifically, the flexible keymat 22 comprises an quarter-pie shape key location to the far right and far left side of its top surface, an respective spherical-shape key location in the center of the flexible keymat 22 circular region, an quarter-pie shape key location above and below the spherical-shape key location at the flexible keymat 22 circular region. Further, one or more grooves may be located between the rows of key dome keymat actuators 15 at the region of the flexible keymat 22 where the circular region region is formed due to more than one key locations arranging near each other. The grooves may be configured to allocate a user to selectively engage with an respective key dome switch 28 without interfering with an nearby opposing key dome switch 28.

Further, the flexible keymat 22 rear surface is disposed at the top surface of the a intermediate layer 5 by any suitable adhesive.

For instance, beads of adhesive may be applied to predetermine regions of the intermediate layer 5 top surface where the flexible keymat 22 may be disposed, further the flexible keymat 22 key locations may be aligned with the cutouts (COO formed on the inner layer 36 and exterior layer 47 from an lateral perspective FIG. 7C.

Furthermore, an respective key top 19 for each key location is disposed at the top surface of the flexible keymat 22. The key tops 19 forms an hollow structure having an circling recessed region 73 slightly adjacent the flanged edges 79 at its inner base surface. Each respective key top 19 circling recessed region 73 allocates the recessed region 73 to assemble on top of the keymat 22 projecting lip 77 at each key location. The key tops 19 body lower region comprises an slight flanged edge 79 prolonging outwardly. The key tops 19 may be further defined as plunger style key tops 19 FIGS. 7D & 7E. Further, the key tops 19, is preferably made of flexible or semi-flexible materials such as plastic, thermoplastic, ethylene vinyl acetate (EVA), Kraton styrene polymer material, PVC, ENGAGE, polyethylene polymer, an light-transmitting silicon rubber, an thermoplastic elastomer or an (e.g., a light-transmitting, flexible rubber material. Alternatively, the keytops 19 may comprise an color other than an transparent clear such as black, red, blue, green, gray and yellow. Specifically, the key tops 51 are formed from an material having an heavier density than the flexible keymat 22. The key tops 19 is adhered on top of the flexible keymat 22 with elastic glue or other suitable adhesives between the key top 19 and flexible keymat 22.

The flexible keymat 22 comprises five respective key tops 9a-9e that corresponds with the wrist sleeve portion 9 quarter-pie shaped cutouts (CO), spherical-shape cutout (SCO) and flexible keymat 22 key locations.

Specifically, the flexible keymat 22 comprises an quarter-pie shape key top 9a at an far left region disposed at cutout 1 (CO1), an quarter-pie shape key top 9b at an far right region disposed at cutout 2 (CO2), an oval-shape key top 9e disposed at cutout 3 (CO3), an respective quarter-pie shape key top 9c disposed at cutout 5 (COS) below the oval-shape key top 9e and an respective quarter-pie shape key top 9d disposed at cutout 4 (CO4) above the oval-shape key top 9e FIG. 7F.

Moreover, each respective quarter-pie key top (9a-9d) comprises an arrow symbol formed on its top surface that points at the direction corresponding to the pointed tip of each respective key top 19. For instance, the direction of the arrow symbol pointed end may correspond with the direction of the key top 19 pointed end. Further, key top 9e comprises the word ENTER formed in its top surface. For instance, each respective key top 19 may be black or an non-transparent color but the arrow symbol and word ENTER disposed on the key tops 19 may be transparent allocating light to pass through.

Specifically, when key top 9a is depressed this input refers to toggling an curser to the right. When key top 9b is depressed this input refers to toggling an curser to the left. Further, when key top 9c is depressed this input refers to toggling an curser to the downward. However, when key top 9d is depressed this input refers to toggling an curser to the upward. Further, when key top 9e is depressed this input refers to an input command for selecting an item. For instance, each respective key top 19 may be black or an non-transparent color but the arrow symbol and word ENTER disposed on the key tops 19 may be transparent allocating light to pass through.

Though when the key tops 19 are disposed on the flexible keymat 22 the exterior layer 47 and inner layer 36 may overlap the key top 19 flange edges 79 leaving an partial spacing 65 intermediate the an lower region of the key tops 19 and exterior layer 47 from an lateral perspective. Therefor, an trim member 24 is disposed around each respective key top 9a-9e at the top surface of the exterior layer 47 that covers the partial spacing 65. Specifically, the exterior layer 47 comprises four respective trim members 24 forming an quarter-pie shape corresponding with key tops 9a-9e and two trim member 24 forming an oval-shape corresponding with key top 9e and cutout 6 (CO6).

Specifically, the top surface of the exterior layer 47 comprises an respective quarter-pie shape trim member 24 disposed at key top 9a, an quarter-pie shape trim member 24 disposed at key top 9b, an oval-shape trim member 24 disposed at key top 9e, an respective quarter-pie shape trim member 24 disposed at key top 9c, an respective quarter-pie shape trim member 24 disposed at key top 9d and an respective oval-shape trim member 24 disposed at cutout 6 (CO6) FIG. 7G.

The trim members 24 are approximately 1.5 mm to 3 mm according to thickness. The trim members 24 may be made of an flexible or non-flexible plastic, metal, aluminum, an light-transmitting silicon rubber, or an thermoplastic elastomer (e.g., a light-transmitting, flexible rubber material), or other suitable materials may be used. For instance, the trim member 24 may be coated with one or more colors or chrome or gold plated. The trim members 24 is disposed on the exterior layer 47 top surface by any suitable adhesive, where adhesive is applied to its bottom surface of the trim member 24 and the trim member 24 is disposed onto the exterior layer 47 top surface within the partial spacing region.

Moreover, the keyboard assembly comprises an respective keydome layer 8 disposed intermediate the flexible keymat 22 and second flexible printed circuit 72 forming an thin flexible sheet-like structure. The keydome layer 8 may be made of an flexible foil, plastic conductive material other suitable flexible conductive materials may also be used. The keydome layer 8 comprises an plurality of keydome switches 28 disposed on its top surface that comes in contact with the one or more contact pad disposed on the second flexible printed circuit 72 generating one or more electrical signals to the second flexible printed circuit 72, in response to an user depressing an respective key top 19 and the key dome keymat actuators 15 coming in contact with an respective keydome switch 28 (e.g., depressing the keydome switch 28) formed on the keydome layer 4.

The keydome layer 8 constitute an insulating foil, preferably plastic foil, where one or more metallic keydome switches 28 are disposed at each key location so that the metal dome may be attached to the insulating foil facing to the second flexible printed circuit 72 but not contacting the contact pads on the second flexible printed circuit 72 if an respective key top 19 is not depressed. Further, the keyboard assembly keydome layer 8 is disposed between the flexible keymat 22 and second flexible printed circuit 72 at the rear surface of the intermediate layer 5 where each keydome switch 28 is located in the openings of the intermediate layer 5 FIG. 7H.

Further, the keydome layer 8 is disposed onto the rear surface of the intermediate layer 5. The keydome layer 8 is coupled to the intermediate layer 5 by any suitable adhesive.

The second flexible printed circuit 72 may also comprise one or more light emitting diodes (LEDs) or other light sources disposed on its top surface configured to illuminate the transparent or translucent flexible keymat 22, key tops 19 and trim members 24. For instance, the intermediate layer 5, inner layer 36, and keydome layer 8 may comprises one or more openings corresponding with each other that may allocate light emitted from the one or more LEDs to illuminate the one or more keytops 19, flexible keymat 22 and trim members 24. The keymat 22 keytops 19 and keydome switch actuators 15 are positioned according to the location of the keydome switches 28 arranged on the bottom surface of the inner layer 3.

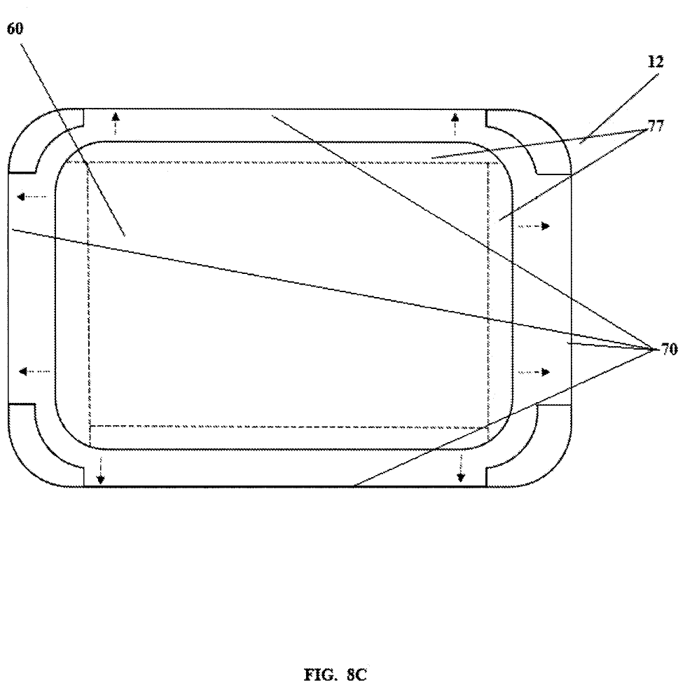

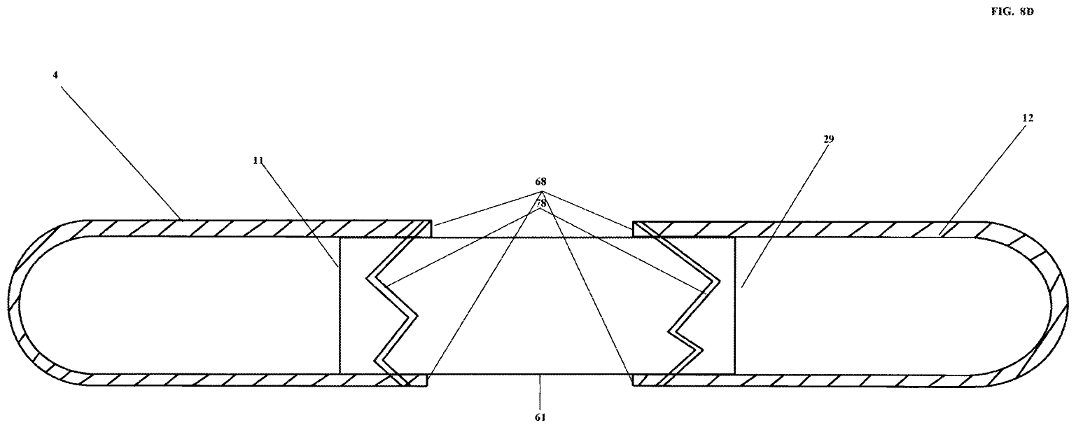

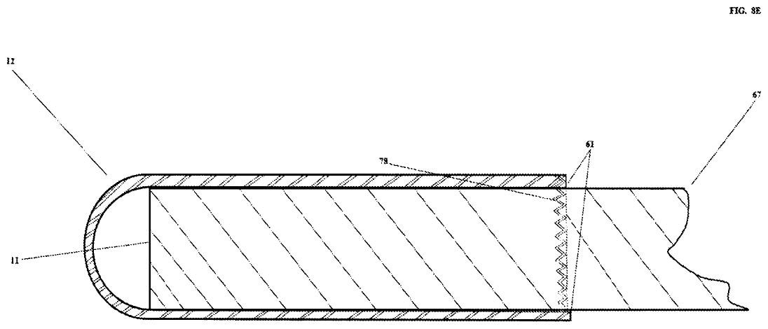

Referring to FIG. 8A, shows the Sports Retronic Wearable Terminal 1001 having an flexible display assembly 13 and an respective flap assembly 12 that may be referred to as an folding type terminal, Further, when the Sports Retronic Wearable Terminal 1001 comprises an flap assembly 12 the terminal is capable of being open and close via an intermediate segment 11. Further, the flap assembly 12 comprises an respective flexible plastic sack 60 comprising an inserting region 69 and an respective pull-tab 67 which allocates the flap assembly 12 to be separated from the display assembly 13 via an user pulling the pull-tab 67 at a direction away from the display assembly 13.

FIG. 8B is an illustration of the flexible plastic sack 60. FIG. 8C is an illustration of the flexible plastic sack 60 disposed within the flap assembly 12. According to the preferred embodiment, the flexible display assembly 13 may comprise the same components and structuring as the flexible display assembly 13 disclosed previously above. FIG. 8D is an cross-sectional view illustrating how the flexible display assembly 13 is coupled to the flap assembly 12. FIG. 8E is an cross-sectional view illustrating how the pull-tab 67 is coupled to the flap assembly 12.

In the preferred embodiment, the flexible flap assembly 12 forms an reedy quadrilateral-shape with outer edges that partially curve. The flap assembly 12 forming an quadrilateral-shape comprising an center opening 10 that prolongs outwardly leaving in the range of 11.43 mm and up of the flap assembly 12 constituting an window (e.g., center opening). The flap assembly 12 may be made of an silicone rubber, leather or flexible plastic material. The flap assembly 12 comprises an thickness of approximately 1.27 mm and up, corresponding with the dimensions of the flexible display assembly 13. For instance, to form the flap assembly 12 one or more layers of rubber, leather or plastic materials may be laminated together, 3D-printed or any other methods known to one skilled in the art(s) to form the flap assembly 12. In addition, the flap assembly 12 comprises an flexible plastic sack 60 disposed within its center opening 10 (e.g., window) comprising an inserting region 69 configured to house an play-card or the likes. The flexible plastic sack 60 may be made of materials such as an transparent plastic. However, upon coupling the flexible plastic sack 60 to the flap layer 12, the flexible plastic sack 60 comprises in the range of 3 mm and up of excess film 77 at its top, bottom and side region this allocate the flexible plastic sack 60 to be disposed within the flap assembly 12 inner lips 70 FIG. 8B.

In order to couple the flexible plastic sack 60 to the flap assembly 12 the flap assembly 12 inner lips 70 is partially bifurcated to allocate the flexible plastic sack 60 excess film 77 (begins at dashed lines) to be inserted within the inner lips 70, an small amount of adhesive may be applied to the inner surface of the inner lips 70, the flexible plastic sack 60 excess film 77 is then disposed within the inner lips 70 and flap assembly 12 is stitched 78 at one or more regions near its boarding (e.g., outer edges and an opposing predetermine region) coupling the flexible plastic sack 60 within the flap assembly 12. The flexible plastic sack 60 is coupled to the flap assembly 12 via an stitching and adhesive process FIG. 8C.

However, the present embodiment, shows the flexible display assembly 13 and flap assembly 12 in relations to one another via an intermediate segment 61 disposed intermediate the flexible display assembly 13 and flap assembly 12. Further, the intermediate segment 61 forms an quadrilateral-shape thin strip form preferably from an flexible material. The intermediate segment 61 can be made of an thin flexible material such as silicone rubber, leather, plastic, an fabric or other suitable materials may be used. The intermediate segment 61 comprises an thickness of in the range of 1.27 mm and up.

To couple the intermediate segment 61 to the flexible display assembly 13 and flap assembly 12 the flexible window layer 4 top outer lips 68 and flap assembly 12 bottom outer lips 68 are partially bifurcated to allocate the intermediate segment 61 distal edges 11, 29 to be inserted within the outer lips 68, an small amount of adhesive is applied to the inner surface of the outer lips 68, the intermediate segment 61 distal edges 11, 29 is then disposed within the outer lips 68 and the display assembly and flap assembly is stitched 78 at one or more regions near its boarding (e.g., outer edges and an opposing predetermine region) coupling the intermediate segment 61 to the flexible window layer 4 and flap assembly 12 FIG. 8D.

Furthermore, the flap assembly 12 comprises an pull-tab 67 disposed laterally at an central top region of the flap assembly 12. Specifically, the pull-tab 67 body forms an quadrilateral-shape thin strip. The pull-tab 67 can be made of an thin material such as silicone rubber, leather, plastic, an fabric other suitable materials may be used. The pull-tab 67 comprises an thickness in the range of 3.21 mm and up.

Moreover, in order to couple the pull-tab 67 to the flap assembly 12 the top region of the flap assembly 12 lips 61 are partially bifurcated to allocate the pull-tab 67 distal edges 11 to be inserted within the lips 61, an small amount of adhesive is applied to the inner surface of the lips 61, the pull-tab 67 distal edges 11 is then disposed within the lips 61 and the lips 61 are stitched 78 closed at one or more regions (e.g., outer edges and an opposing predetermine region) coupling the pull-tab 67 to the flap assembly 12 FIG. 8E.

Further, the pull-tab 67 comprises an respective attaching mechanism 131 disposed laterally at an midway region of its interior surface. The attaching mechanism 131 may allocate the flap assembly 12 and flexible widow housing 4 to respectively attach to one another at an locking fashion. The attaching mechanism 131 may be an velcro strip or magnet and may be coupled to the pull-tab 67 by any suitable adhesives. More of, the flexible window housing 4 comprises an respective attaching mate/pad 132 disposed laterally at an lower midway region of its exterior surface. The attaching mate/pad 132 may be an velcro pad or magnet and may be coupled to the flexible window housing 4 by any suitable adhesives.

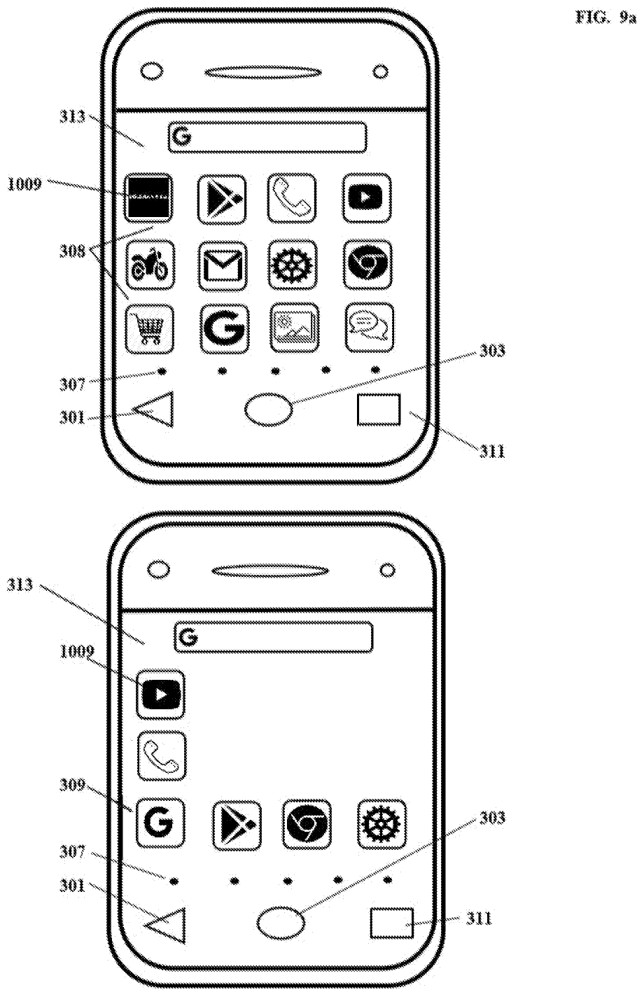

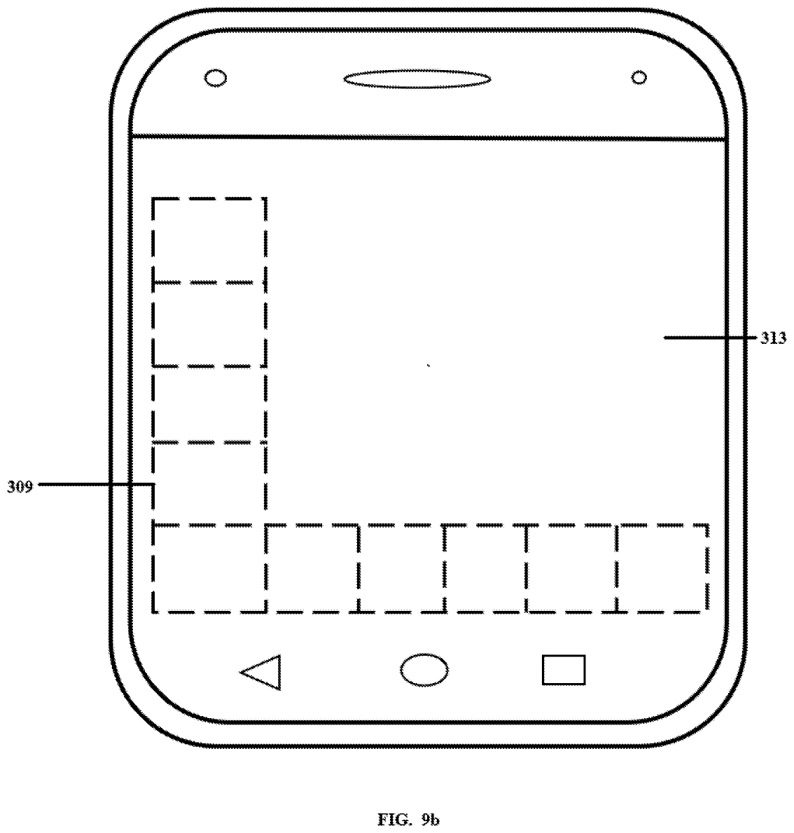

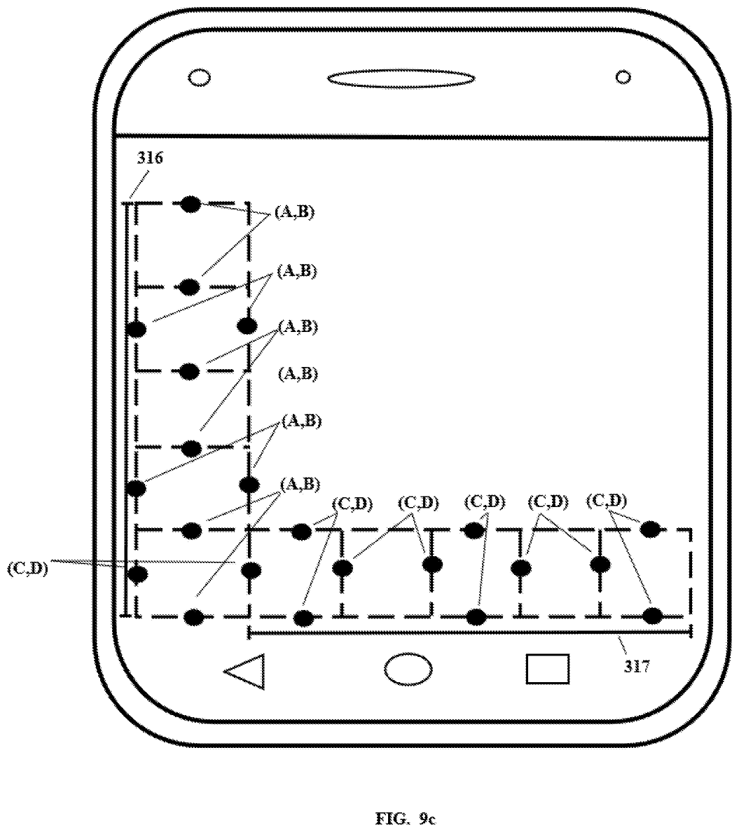

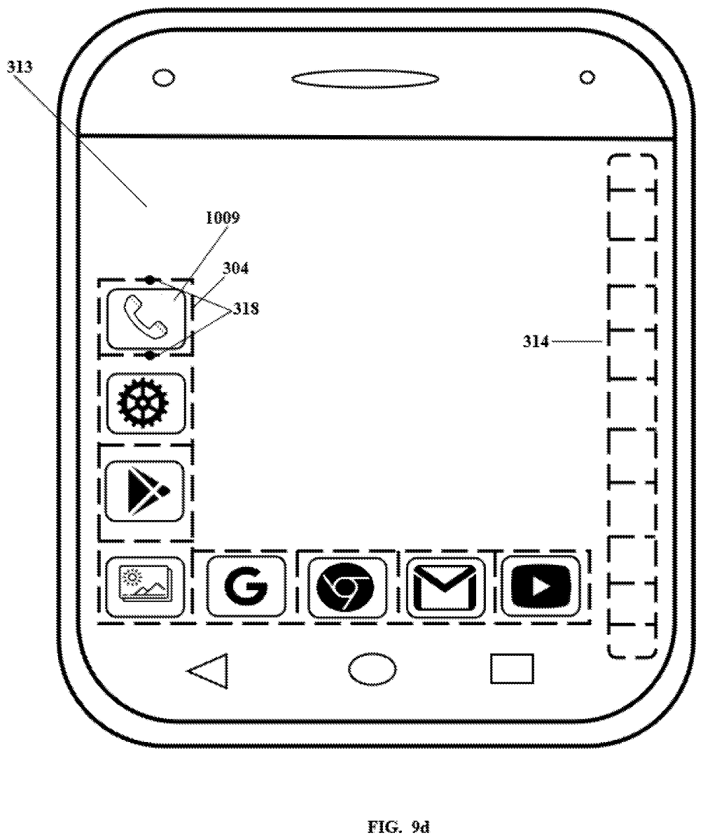

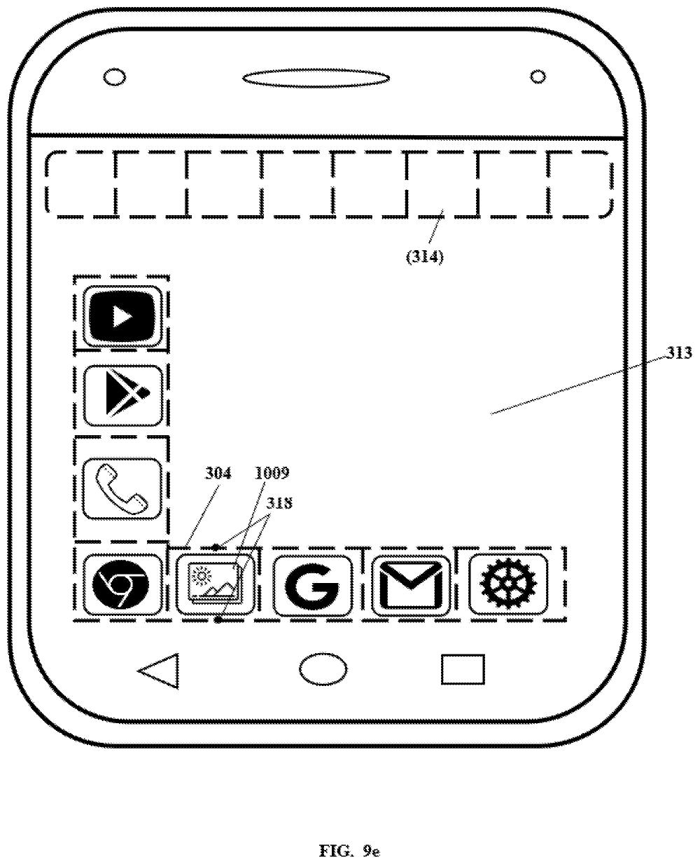

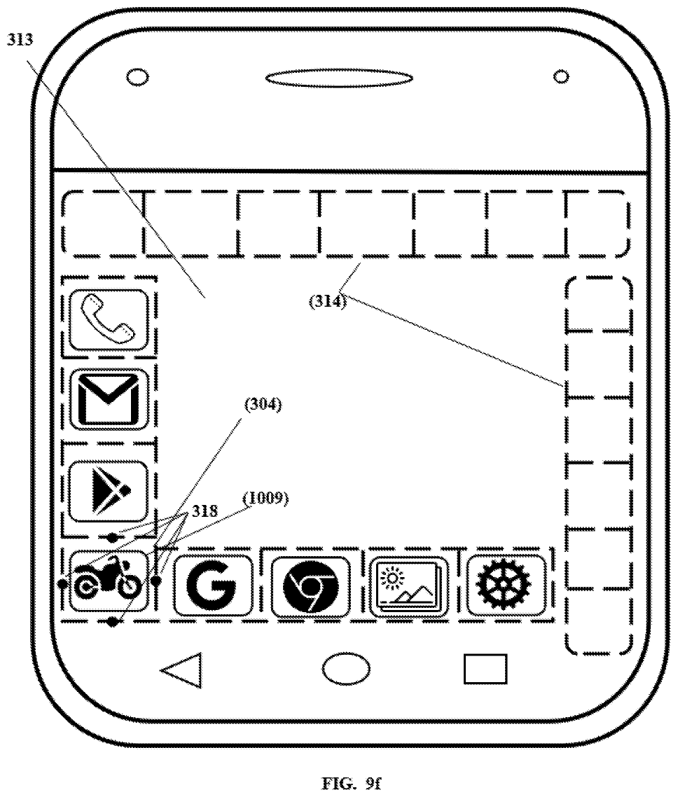

FIG. 9a is conceptual views showing embodiments of a mobile terminal 136 user interface displaying and opening the one or more objects 1009 according to an embodiment of the present invention. For example, the objects 1009 displayed on the display 6 may be a clickable object such as a icon, web browser, application, widget, music file (e.g., mp3 or mp4), photo, video, mobile terminal functions windows, files, alerts or other identifiable system objects. For example, the graphical user interface 313 may comprises one or more screens such as a home screen, second screen, third screen etc., the one or more screens may comprises one or more objects 1009, the user may be able to toggle between the one or more screens by way of a first action (e.g., swipe, drag or scroll gesture) on the display 6. The display 6 graphical user interface 313 may comprise means for indicating the amount of screens such as screen indicator notch 307. For example, the graphical user interface 313 may comprise three screen indicator notches 307 a home screen notch, second screen notch and third screen notch, as the user toggle (e.g., swipe) between screens the screen indicator notch 307 also alternate to an predetermine screen indicator notch 307 associated with the current screen.

The user may access a web browser and cause the display 6 graphical user interface 313 to display web browser by way of a input (e.g., selecting) to a web browser object (e.g., icon), the user may place a phone call and cause the display 6 graphical user interface 313 to display phone function objects by way of a input (e.g., selecting) to a phone function object (e.g., icon), the user may access e-mail functions and cause the display 6 graphical user interface 313 to display a e-mail function objects (e.g., icon) by way of a input (e.g., selecting) to a e-mail object (e.g., icon), the user may access video player functions and cause the display 6 graphical user interface 313 to display video player processing objects by way of a input (e.g., selecting) to a video player object (e.g., icon), the user may access picture/video gallery functions and cause the display 6 graphical user interface 313 to display picture/video gallery objects by way of a input (e.g., selecting) to a picture/video gallery object (e.g., icon) the user may access a mobile game/application and cause the display 6 graphical user interface 313 to display a mobile game/application function by way of a input (e.g., selecting) to a mobile game/application object (e.g., icon) and the user may access a web browser or search a particular subject, term or keyword and cause the display 6 graphical user interface 313 to display web browser or search browser by way of a input (e.g., selecting) to a search browser object (e.g., icon).

In addition to opening a object functions in a second user interface (e.g., application user interface) the user may be able to return to the home screen of the display 6 graphical user interface 313 by way of a first action (e.g., selecting) to a home object (e.g., icon) 303. Further, during opening the object functions in the second user interface the user may be able to toggle to an previous page of the object functions within the second user interface or the home screen of the graphical user interface 313 depending on the amount of inputs to a back object (e.g., icon) 301.

During operation of the mobile terminal 136 weather if the user have or haven't opened object functions in a second user interface the display 6 graphical user interface 313 is configured to display a task view grouping the one or more prior opened object functions by way of a first action (e.g., selecting) to a task view object (e.g., icon) 311, during the displaying of the task view from the graphical user interface 313 the user may be able to reopen and/or clear the one or more prior opened object functions.

FIGS. 9b-9d is conceptual views showing embodiments of a mobile terminal 136 graphical user interface 313 for aligning one or more predetermine objects 1009 during object flicking mode according to an embodiment of the present invention.

Further, upon the user executing object flicking mode the one or more processor(s) 7 is configured to align the objects 1009 (e.g., positions) such as the icons from a stacked column alignment 308 to a L-shape alignment 309 FIG. 9b. For example, the L-shape alignment 309 may be automatic or manually preformed in response to the user executing object flicking mode. During alignment of the one or more objects (e.g., icons) 1009 a L-shape grid 300 having predetermine intervals is displayed on the display 6 graphical user interface 313 and the one or more screens and the one or more objects 1009 are aligned according to a setting automatic or manually alignment (or automatic sorting or manual sorting). The size of the horizontal and vertical intervals of the L-shape grid 300 may be changed arbitrarily by the user. If the alignment of the one or more objects 1009 is set as automatic alignment, the one or more processors moves the one or more objects 1009 of the display 6 graphical user interface 313 to contact points of the nearest grids, respectively.

Furthermore, during manual alignment (or manual sorting) of the one or more objects 1009 of the display 6 graphical user interface 313 the user may be able to fix the objects 1009 at locations of particular coordinate points. The user may fix the objects 1009 with a high use frequency at locations (e.g., points that can be easily recognized by the user).

In addition, when the one or more processor(s) 7 displays the grids on the display 6 graphical user interface 313 one or more screens during alignment of the objects 1009 the one or more processor(s) 7 may apply a special effect (e.g., alpha blending) to the background image so that the objects 1009 and the L-shape grid 300 can be more emphasized (or conspicuous)

According to FIG. 9c, each respective cell 304 of the L-shape grid 300 comprises one or more axis points 318 at predetermine regions of the cell 304 configured to determine a respective object opening region 314 to generate on the display 6 under the control of the one or more processor(s) 7. Further, the L-shape grid 300 comprises a vertical segment 316 and horizontal segment 317 having respective cells 304, each respective cell 304 of the vertical segment 316 comprises axis points (a,b) and each respective cell 304 of the vertical segment 316 comprises axis point (c,d).

Furthermore, when a object (e.g., icon) 1009 is aligned within a respective cell 304 of the L-shape grid 300 the respective object 1009 is associated with a respective axis point 318 of that grid 304. If, an object (e.g., icon) 1009 is aligned within a respective cell 304 having a axis points 318 of (a,b) the one or more processor(s 7 generate a object opening region 314 at the right side of the display 6 graphical user interface 313 FIG. 9d. If, an object (e.g., icon) 1009 is aligned within a respective cell 304 having a axis points 318 of (c,d) the one or more processor(s) 7 generate a object opening region 314 at the top side of the display 6 graphical user interface 313 FIG. 9e. However, the last cell 304 of the horizontal segment 317 comprises a axis point 318 of (a,b and c,d). Though, when the user provides a first action with the object icon) 1009 of the last cell 304 the one or more processor(s) 7 generate a object opening region 314 at the right side and top side of the display 6 graphical user interface 313, and when the user provides a second action in conjunction with the first action of the object (e.g., icon) of the last cell 304 the object functions is configured to be executed in a second user interface 310 in response to the user second action to the right or top side of the display 6 graphical user interface 313 FIG. 9f.

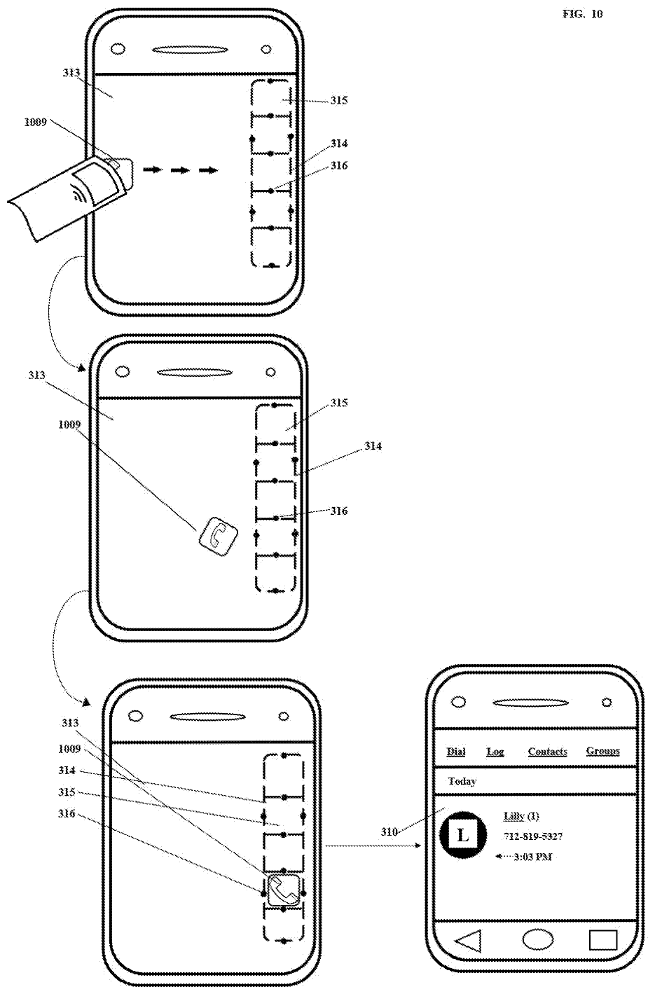

FIG. 10 is conceptual views showing embodiments of a mobile terminal 136 graphical user interface 310 displaying and executing the opening of the one or more objects 1009 during object flicking mode according to an embodiment of the present invention. Object flicking mode refers to a mode in which the one or more objects 1009 of the display 6 graphical user interface 310 processing functions is opened in response to an user first action in conjunction with a second action with the object 1009.

Additionally, during object flicking mode predetermine objects (e.g., icons) 1009 of the display 6 graphical user interface 313 are rearranged, and is opened in a second user interface (e.g., application user interface) in response to an user first action in conjunction with a second action with the object 1009. The user first action can be any of a itemizing or selection of the object 1009. The first action may be to itemize select or click) the object 1009 while executing the second action. The user second action can be a flicking or dragging of the object 1009 towards an predetermine region of the display 6 graphical user interface 310. In reference to FIG. 9a, the graphical user interface 313 comprises one or more predetermine objects 1009. The one or more objects (e.g., icons) 1009 consist of a camera application icon, phone application icon, email application icon, a messaging application icon, music player application icon, video player application icon, alarm application icon, internet browser application icon, music file icon (e.g., mp4, mp3, etc.), a gallery application, a search bar icon, mobile video game application icon, mobile terminal functions settings application icon, file manager application icon, clock application icon, banking application icon, calculator application icon, a social media application icon and a search bar.

Further, in response to the user first action of a predetermine object (e.g., icon) 1009 the one or more processor(s) 7 is configured to generate a object opening region 314 on the display 6 graphical user interface 313. Although the one or more processor(s) 7 is executed to display the object opening execution region 314 on the display 6 graphical user interface 313, second user interface 310 or a corresponding user interface of the second user interface 313 in response to the user first action with a object 1009 of the display 6 graphical user interface 313 second user interface 310 or corresponding user interface of the second user interface 310, the object opening region 314 is internally set, without being displayed on the display 6 graphical user interface 313, second user interface 310 or a corresponding user interface of the second user interface 310 in response to the user first action with a object 1009 of the display 6 graphical user interface 313, second user interface 310 or corresponding user interface of the second user interface 310.

The object opening region 314 is a vertical or horizontal respective grid set a predetermine region of the display 6 graphical user interface 313 depending on the user first action with a respective object 1009 (e.g., icon) of a respective cell 304 having predetermine axis points 318. For instance, if the one or more processors 7 generate a vertical object opening region 314 the object opening region 314 extends across the entire right side of the display 6 graphical user interface 310 if the object 1009 is one of the display 6 graphical user interface 313. If the one or more processor(s) 7 generates a vertical object opening region 314 the object opening region 314 extends across the entire right side of the display 6 second user interface (e.g., application user interface) 310 or a corresponding user interface of the second user interface 310 if the object 1009 is one of the second user interface 319 or is one of the corresponding user interfaces of the second user interface 310 in response to the user first and second action with the object 1009 of the second user interface 310. For instance, if the one or more processor(s) 7 generate a horizontal object opening region 314 the object opening region 314 extends across the entire top side of the display 6 graphical user interface 313 if the object 1009 is one of the display 6 graphical user interface 313. If the one or more processor(s) 7 generates a horizontal object opening region 314 the object opening region 314 extends across the entire top side of the display 6 second user interface (e.g., application user interface) 310 or a corresponding user interface of the second user interface 310 if the object 1009 is one of the second user interface 310 or is one of the corresponding user interfaces of the second user interface 310 in response to the user first and second action with the object 1009 of the second user interface 310.

The object opening region 314 comprises one or more respective grid cells 315 having one or more contact points 316. In response, to the user second action with the object 1009 at least one grid cell 315 of the object opening region 316 is configured to receive the object 1009 and the one or more processor(s) 7 is configured to execute the predetermine object functions in a second user interface 310. The grid cells 315 of the object opening region 314 may be sized according to the respective object 1009. The object opening region 314 can be of one or more shapes corresponding with the predetermine object 1009. For instance, the user first action may be a circle, square or oval shape object 1009, in response the one or more processors may generate a circle, square or oval shape grid having respective grid cells 315, For instance, during the user second action with the object 1009, the object 1009 is automatically aligned within at least one grid cell 315 of the object opening region 314. Though, when the one or more processor(s) 7 displays the object opening region 314 grids cells 315 on the display 6 graphical user interface 313 the one or snore processor(s) 7 applies a special effect (e.g., alpha blending) to the background image so that the objects 1009 and the grids cells 315 can be more emphasized (or conspicuous).

However, in response to e user first action in conjunction with the second action of a predetermine object (e.g., icon) 1009 of the display 6 graphical user interface 313 the one or more processor(s) 7 is configured to temporary remove unselected objects g., icons) 1009 from the L-shape alignment of the display 6 graphical user interface 313 until the one or more processor(s) 7 does not detect the user first and second action.

Further, in response to the user second action the object 1009 is configured to move freely without further input (e.g., holding the object 1009) provided by the user. During the user second action with the object 1009 the object 1009 moves across the display 6 according to the user force sensed by one or more processor(s) 7 detecting a force of one or more sensors (e.g., force or touch sensors) of the display 6. For instance, the user second action may be a light action causing the object 1009 to glide across the display 6 at a short or moderate distance, however the user second action may be a heavy action causing the object 1009 to glide across the complete side of the display 6. Further, in response to the user second action of the object 1009 the object 1009 is configured to rotate counter-clockwise or clockwise across display 6. The rotation of the object 1009 varies depending on a force sensed by the one or more processor(s) 7 detecting a force of one or more sensors (e.g., touch or force sensors) of the display 6.

For instance, the user second action may be a light action causing the object 1009 to rotate across the display 6 gradually or moderate, however the user second action may be a heavy action causing the object 1009 to rotate across the display 6 quickly.

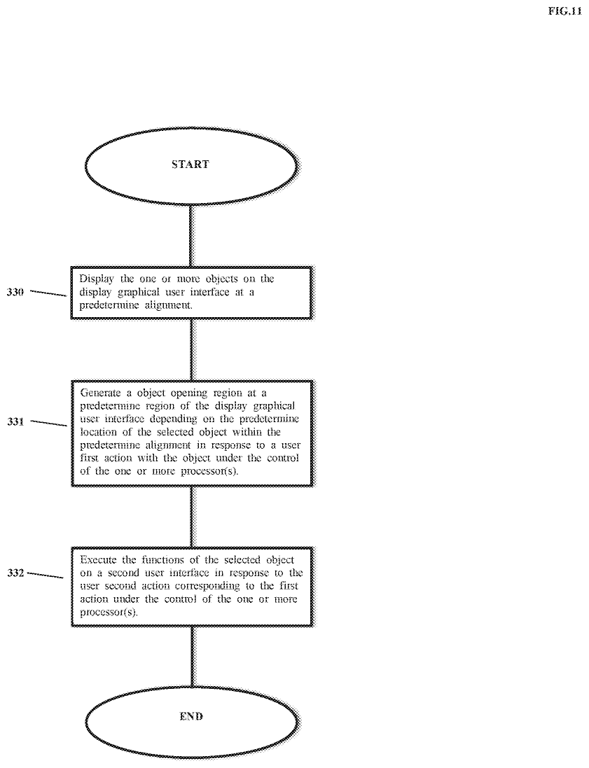

FIG. 11 is a flow chart illustrating method steps of flicking object mode on a mobile terminal 136 user interface according to an exemplary embodiment of the present invention. The graphical user interface 310 may display a plurality of objects 1009 related to certain functions. The user may select a predetermine object 1009 desired to be opened in a second user interface 313 among the plurality of objects 1009 of the display 6 graphical user interface.

The mobile terminal 136 may display a plurality of objects (e.g., icons) 1009 related to certain functions on the display 6 graphical user interface 313. The user is capable of executing flicking object mode, from one or more settings on the mobile terminal 136. The setting can be accessible from a drop-down menu, side panel, or main settings of the mobile terminal 136 (S330). Further, when object flicking mode is executed the one or more processor(s) 7 is configured to rearrange the layout of predetermine of objects (e.g., icons) of the display 6 graphical user interface 313. Specifically, the one or more processor(s) 7 is configured to align the objects 1009 (e.g., positions) such as the icons from a stacked column alignment 308 to a L-shape alignment 309 as mentioned in reference to FIG. 9b. For example, the L-shape alignment 309 may be automatic or manually preformed in response to the user executing object flicking mode.

Further, the display 6 graphical user interface 313 is configured to display a object opening region 314 at a predetermine region in response to a user first action with a object 1009 under the control of the one or more processor(s) 7 (S331). The user first action can be any of a itemizing or selection of the object 1009. If, the user first action is to an object (e.g., icon) 1009 aligned within a respective cell 304 having a axis points 318 of (a,b) the one or more processor(s) 7 generate a object opening region 314 at the right side of the display 6 graphical user interface 313. If, the user first action is to a object (e.g., icon) 1009 aligned within a respective cell 304 having a axis points 318 of (c,d) the one or more processor(s) 7 generate a object opening region 314 at the top side of the display 6 graphical user interface 313. If, the user first action is to a object 1009 of the last cell 304 of the horizontal segment 317 comprising axis points 318 of (a,b and c,d) the one or more processor(s) 7 generate a object opening region 314 at the right side and top side of the display 6 graphical user interface 313, and when the user provides a second action in conjunction with the first action of the object (e.g., icon) of the last cell 304 the object functions is configured to be executed in a second user interface 310 in response to the user second action to the right or top side of the display 6 graphical user interface. Furthermore, the one or more processor(s) 7 is configured to is execute the functions of the selected object 1009 on a second user interface (e.g., application user interface) 310 in response to the user second action corresponding to the first action with the object 1009 (S332). The user second action can be a flicking or dragging of the object 1009 towards an predetermine region of the display 6 graphical user interface 313 depending on the object 1009 selected from the horizontal and vertical segments (317, 316).

As described above, the flicking object method according to the exemplary embodiments of the present invention may be implemented by computer-readable codes in a program-recorded medium. The computer readable medium includes any kind of recording device in which data. that can be read by a computer system is stored. The computer-readable medium may include a ROM, a RAM, a CD-ROM, a magnetic tape, a floppy disk, an optical data storage device, and the like. The computer- readable medium also includes implementations in the form of carrier waves or signals (e.g., transmission via the Internet). In addition, the computer may include the one or more processor(s) 7 of the mobile terminal 136.

As so far described, according to the exemplary embodiments of the present invention, the functions of the objects 1009 are implemented to be opened in a second user interface 313, and the mobile terminal 136 can display and operate the functions of the objects 1009. As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, are therefore intended to be embraced by the appended claims.

1. A wrist wearable terminal comprising:
a wrist sleeve portion encircling a wrist of a user having one or more layers made of one or more materials having a predetermine thickness, and wherein the one or more materials consist of the group of: woven or non/woven fabrics of natural or synthetic fibers, flexible or non-flexible plastics, synthetic shammy materials and flexible rubber materials;
a flexible keymat disposed on a intermediate layer having top and rear sides; and
a flap assembly coupled to the display assembly wherein the flap assembly comprises a pull tab and a plastic sack;
wherein the one or more layers of the wrist sleeve portion is coupled together to form a multi-film layer by a lamination, co-extrusion or adhesive process.

2. The wrist terminal of claim 1, whereas a exterior layer 47 comprises any suitable thickness in the range of 0.5 mm and up.

3. The wrist terminal of claim 1, whereas a intermediate layer 5 comprises any suitable thickness in the range of 0.3 mm and up.

4. The wrist terminal of claim 1, whereas a inner layer 36 comprises any suitable thickness in the range of 0.2 mm and up.

5. The wrist terminal of claim 1, whereas a interior layer 14 comprises any suitable thickness in the range of 0.5 mm and up.

6. The wrist terminal of claim 1, whereas a intermediate layer 3 comprises an suitable thickness in the range of 0.3 mm and up.

7. The wrist terminal of claim 1, whereas a inner layer 23 comprises any suitable thickness in the range of 0.2 mm and up.

8. The wrist terminal of claim 1, whereas a structuring layer 41 comprises any suitable thickness in the range of 0.3 mm and up.

9. The wrist terminal of claim 1, further comprising one or more adhesive layers made of a thermoplastic material is disposed on the structuring layer 41 top surface, which allocates a first and second flexible printed circuits to be laminated or thermally adhered to the structuring layer 41 top surface and one or more electrical components to be disposed on the top surface.

10. The wrist terminal of claim 1, further comprising a display assembly disposed on the wrist sleeve portion, and wherein the display assembly comprises a flexible window housing formed of a material consisting of the group of: silicone rubber, leather or flexible plastic material.

11. The wrist terminal of claim 10, wherein the display assembly further comprises a display, and wherein the display comprises one or more protective layers made of a thin flexible transparent material.

12. The wrist terminal of claim 10, further comprising a flap assembly coupled to the display assembly.

13. The wrist terminal of claim 12, wherein the flap assembly is coupled to the display assembly via a intermediate segment.

14. The wrist terminal of claim 9, further comprising one or more micro-electrical components populated onto the first and second flexible printed circuit, and wherein the one or more micro-electrical components consist of the group of: one or more processors, one or more light emitting diodes (LEDs), one or more input modules, a wireless communication module, one or more memory(s), a power management modules, a audio modules, a camera modules and one or more sensing modules.

15. The wrist terminal of claim 1, further comprising a plurality of attachment strips is disposed at a front lower side of the wrist sleeve portion below a keytops.

16. The wrist terminal of claim 1, wherein the flexible keymat forms a thin structure layer having a partial recessed region at each key location, whereas the partial recessed region constitutes a slight bulge at a rear surface of each key location, and further comprising a upward. projecting lip at a front side of each key location rim.

17. The wrist terminal of claim 1, further comprising a plurality of keytops formed of a shape disposed on the flexible keymat top side; wherein the keytops shapes consist of the group of: a quarter-pie shape and a oval-shape.

18. The wrist terminal of claim 1, further comprising a trim member disposed around each respective key top at the top surface of the exterior layer that covers a partial pacing.

19. The wrist terminal of claim 1, further comprising a keydome layer is disposed between the flexible keymat and second flexible printed circuit at a rear surface of the inner layer where each keydome switch is located in a opening of the intermediate layer.

20. A system comprising:
a processor; and
a computer-readable medium coupled to the processor and having instructions stored thereon, which, when executed by the processor, causes the processor to perform operations comprising:
displaying a predetermine shape alignment of one or more objects on a display graphical user interface;
generating, by the processor, a grid constituting a object opening region at a predetermine area of the display graphical user interface varying on the one or more objects selected from the L shape predetermine shape alignment in response to a user first action with the selected one or more objects; and
displaying a function of the one or more objects in a second user interface in response to the user second action with the one or more objects.
